(19) United States
(12) Patent Application Publication
(10) Pub. No.: US 2007/0232381 A1
(43) Pub. Date: Oct. 4, 2007

(54) GAMING MACHINE

(75) Inventor: Kazunobu SATO, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/695,856

(22) Filed: Apr. 3, 2007

(30) Foreign Application Priority Data
Apr. 3, 2006 (JP) 2006-102363

(51) Int. Cl. A63F 13/00

(52) U.S. Cl. 463/20

(57) ABSTRACT

In a slot machine, if a partial image acquisition lottery process is won, the part of contents displayed as a result of a symbol lottery process is stored in an image data storage area as partial image data based on split pattern data determined in a split pattern determination process. If the partial image data is stored in the image data storage area, partial composite image data or a whole composite image data will be generated, and a special award based on the generated partial composite image data or the whole composite image data is provided separately from the award based on the symbol lottery process.

### CROSS-REFERENCE TO RELATED APPLICATIONS

This application is based upon and claims a priority from the prior Japanese Patent Application No. 2006-102363 filed on Apr. 3, 2006, the entire contents of which are incorporated herein by reference.

### BACKGROUND

1. Technical Field

Aspects of the present invention relate to a gaming machine which displays symbols on a display device and provides a payout based on a combination of the symbols.

2. Description of Related Art

Conventionally, slot machines and poker games are known as gaming machines which execute a game awarding a payout based on a combination of symbols displayed on a display device. In one example, various symbols are variably stopped and displayed, and if the symbols stopped and displayed match a predetermined combination, a payout or a bonus game corresponding thereto will be awarded.

In a conventional example, a slot machine is constructed to provide an award including a credit or special game corresponding to the combination pattern of five symbols stopped and displayed on one pay line on a monitor. Thereby, a player can recognize a game result easily based on the combination of the symbols stopped and displayed on the pay line. However, in the present example, the player can always recognize the game result easily based on the combination of the symbols stopped and displayed on the pay line, so the interest such as “surprise” for award content including credit will attenuate. And, if the surprise for the award attenuates, “joy” for awarding of award will attenuate. And more, when the player continues the game, the awards are always awarded based on the predetermined pattern such as the combination of the symbols on the pay line, so it may cause the player to feel that the video slot machine is monotonous.

In another example, in recent years, in a personal computer and in a video game, display patterns displayed on a display device are stored as screenshots. And, the image on the network game is stored and can be published on a network (e.g. Internet).

The image saved is mainly used when the result of the game is to be shown to someone or to represent user progress (such as level) within a game. However, the saved image is used mainly as a communication tool and does not improve the interest in the game.

### SUMMARY

In view of the foregoing, one or more aspects of the present invention relate to a game, gaming machine that provides an award in accordance with a combination of a symbols. Also, in one or more aspects, a symbol is replaced with another symbol stored in a memory device. Further, one or more aspects, award is provided based on a combination of the symbols displayed on the display after the displayed symbol is replaced. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing a slot machine in a first illustrative embodiment in accordance with one or more aspects of the present invention.

FIG. 2 is an explanatory view showing nine variable display portions of the slot machine in the first illustrative embodiment in accordance with one or more aspects of the present invention.

FIG. 3 is an explanatory view showing eight pay lines of the slot machine in the first illustrative embodiment in accordance with one or more aspects of the present invention.

FIG. 4 is a block diagram showing a control system of the slot machine in the first illustrative embodiment in accordance with one or more aspects of the present invention.

FIG. 5 is an explanatory view showing a RAM in the slot machine in the first illustrative embodiment in accordance with one or more aspects of the present invention.

FIG. 6 is a block diagram showing a display drive circuit of the slot machine in the first illustrative embodiment in accordance with one or more aspects of the present invention.

FIG. 7 is a view showing a video reel variably displayed while being scrolled in each of the variable display portions in the first illustrative embodiment in accordance with one or more aspects of the present invention.

FIG. 8 is an explanatory view showing a lottery table to determine the stopped symbols in nine variable display portions in accordance with one or more aspects of the present invention.

FIG. 9 is an explanatory view showing a payout table to indicate the line odds winning combinations and payouts corresponding thereto in the first illustrative embodiment in accordance with one or more aspects of the present invention.

FIG. 10 is an explanatory view showing a payout table to indicate the any odds winning combinations and payouts corresponding thereto in the first illustrative embodiment in accordance with one or more aspects of the present invention.

FIG. 11 is a flowchart showing a main process program in the first illustrative embodiment in accordance with one or more aspects of the present invention.

FIG. 12 is an explanatory view schematically showing split pattern data in the first illustrative embodiment in accordance with one or more aspects of the present invention.

FIG. 13 is an explanatory view showing a split pattern lottery table in the first illustrative embodiment in accordance with one or more aspects of the present invention.

FIG. 14 is an explanatory view showing a partial image acquisition table in the first illustrative embodiment in accordance with one or more aspects of the present invention.

FIG. 15 is an explanatory view showing a display pattern on a lower display when a bonus game is won.

FIG. 16 is a flowchart showing a bonus game process program in first illustrative embodiment in accordance with one or more aspects of the present invention.

FIG. 17 is a flowchart showing a partial image data acquisition process program in the first illustrative embodiment in accordance with one or more aspects of the present invention.

FIG. 18 is a flowchart showing a game process program in first illustrative embodiment in accordance with one or more aspects of the present invention.

FIG. 19 is a flowchart showing a composite image generation process program in first illustrative embodiment in accordance with one or more aspects of the present invention.

FIG. 20 is a view showing an example of an acquisition of the partial image data.

FIG. 21 is an explanatory view showing a generation of a partial composite image data based on the partial image data explained in FIG. 20 and an acquisition of the partial image data based on the split pattern data.

FIG. 22 is an explanatory view a condition in which the partial composite image data generated in FIG. 21 is displayed on the lower display.

FIG. 23 is an explanatory view showing an acquisition of a partial composite image data based on the partial image data explained in FIG. 21 and an acquisition of the partial image data based on the split pattern data.

FIG. 24 is an explanatory view a condition where the partial composite image data generated in FIG. 23 is displayed on the lower display.

FIG. 25 is an explanatory view a generation of the whole composite image data based on the partial image data acquired in FIGS. 20, 21, and 23.

FIG. 26 is an explanatory view a condition where the whole composite image data generated in FIG. 25 is displayed on the lower display.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that the invention may be implemented as computer executable instructions on a computer readable medium such as a non-volatile memory, a magnetic or optical disc or an audio-frequency, radio-frequency or optical carrier wave.

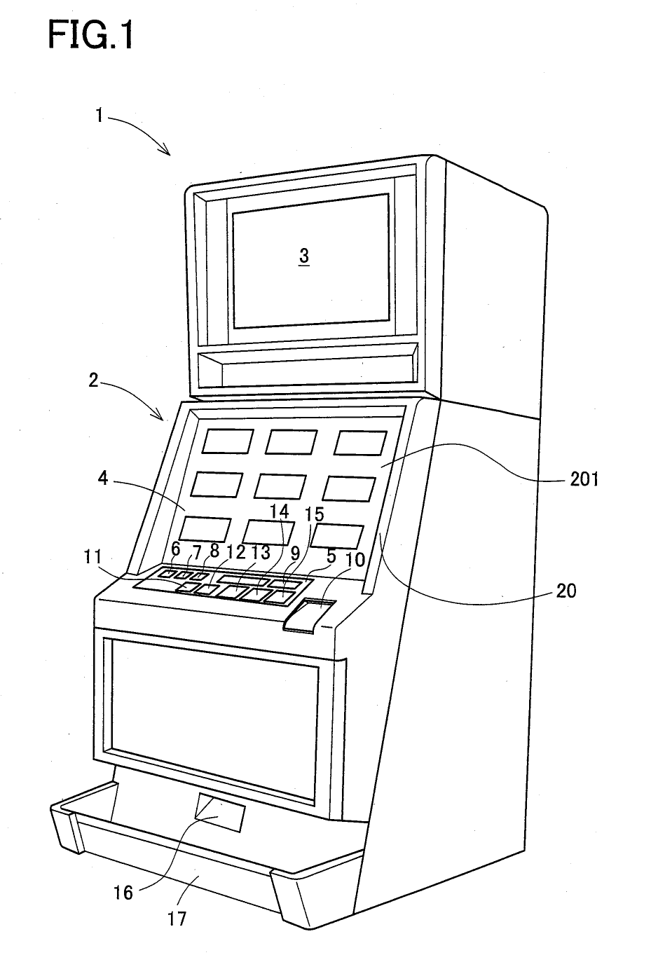

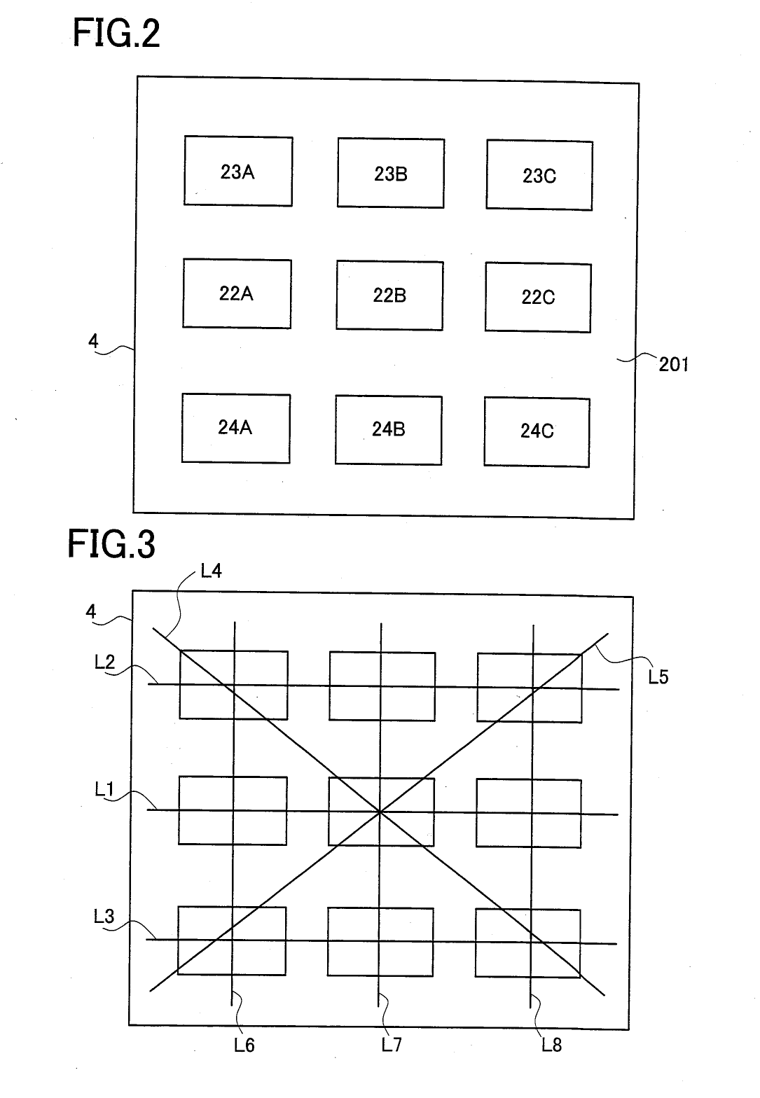

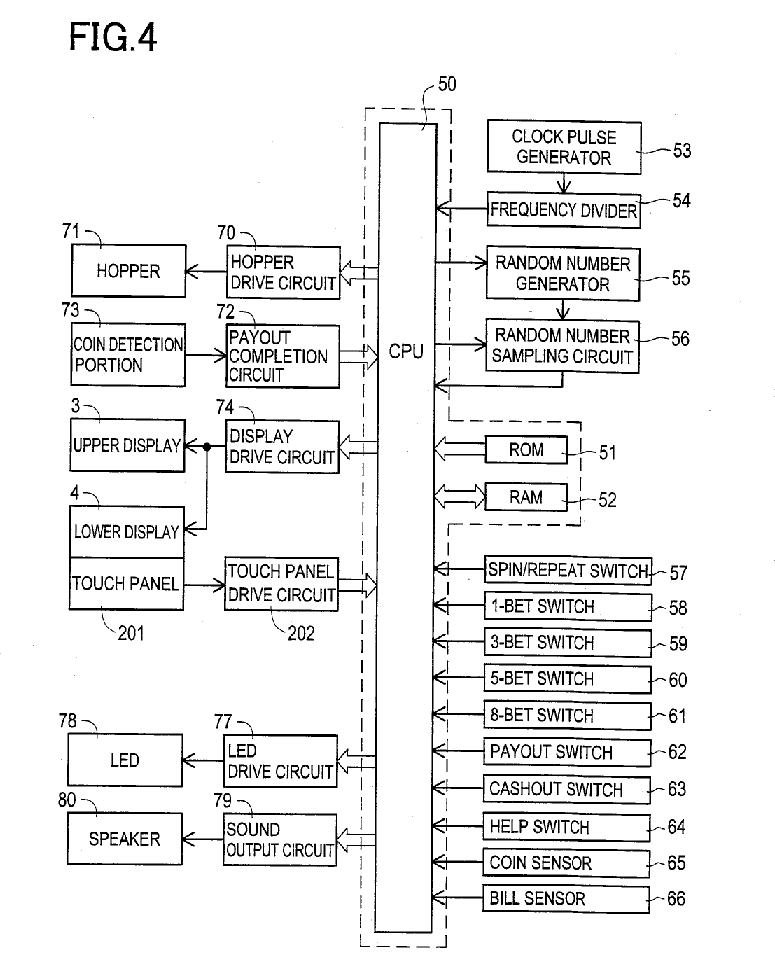

At first, the construction of the slot machine according to one or more embodiments will be described with reference to FIGS. 1 to 4. FIG. 1 is a perspective view showing a slot machine. FIG. 2 is a perspective view showing nine variable display portions. It is appreciated that the number of variable display portions may be other values as well (including but not limited from two to twenty five, for instance). FIG. 3 is a perspective view showing eight pay lines. Here again, the number of pay lines is variable. FIG. 4 is a block diagram showing an example of a control system of the slot machine.

As shown in FIG. 1, a slot machine 1 has a cabinet 2. An upper display 3 is positioned in the upper front part of the cabinet 2, and a lower display 4 is positioned on a device front panel 20 positioned in the front center part of the cabinet 2. Displays 3 and 4 may be CRTs, liquid crystal displays, plasma displays, LED displays, OLED displays, and other known display technologies. For instance, one or both the upper display 3 and the lower display 4 may be a liquid crystal display. A transparent touch panel 201 is positioned on the front surface of the lower display 4. Transparent touch panel 201 may form part or all of a selection device. It is appreciated that other structures may be used in place of touch panel 201 including buttons and the like. The term “selection device” encompasses various structures that permit a user to select an item. It is appreciated that CRTs and other display technologies may be used in place of or in conjunction with the displays 3 and 4. Further, in some aspects, the upper display 3 and the lower display 4 may be combined into a single display or further separated into three or more displays.

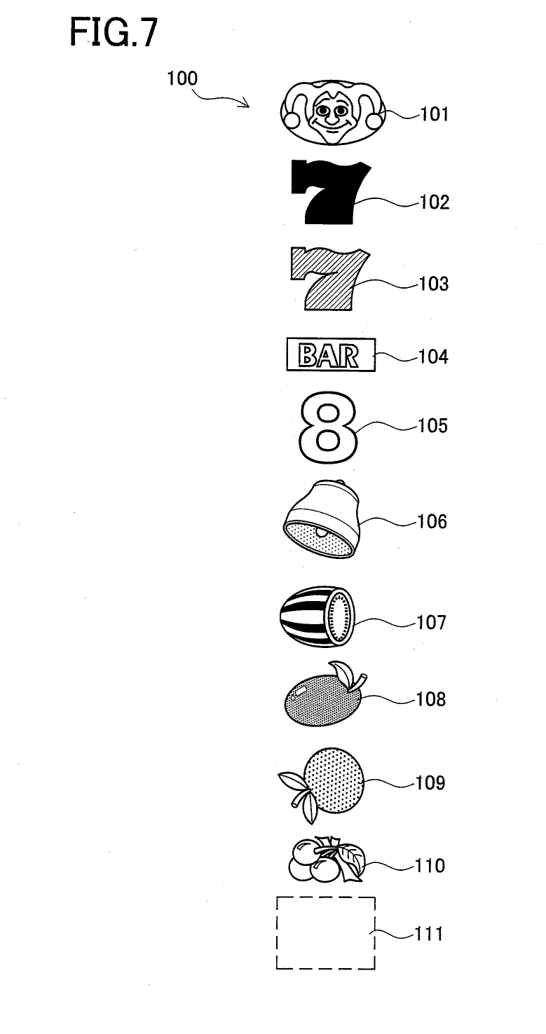

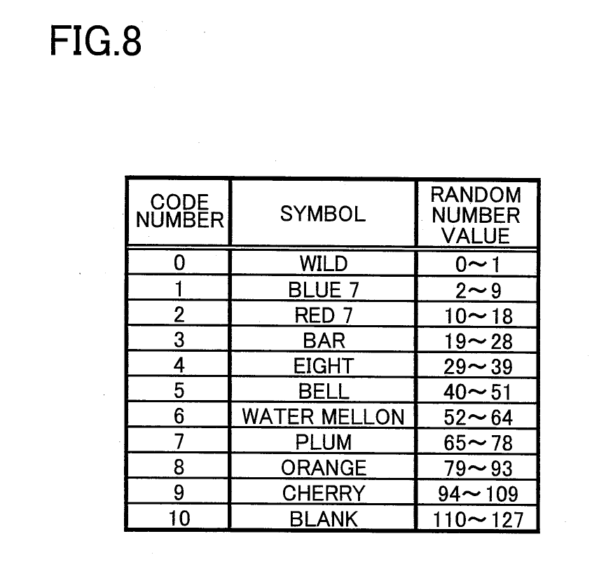

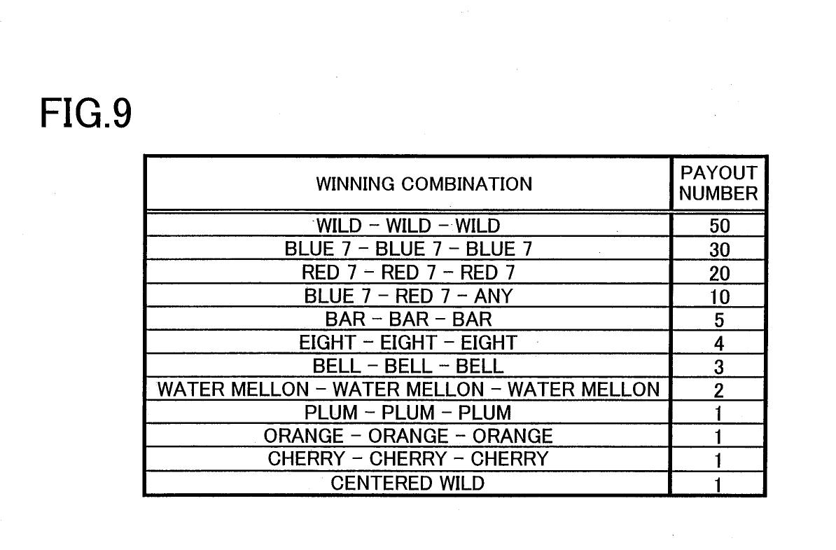

The upper display 3 displays information on a game such as a game method, a payout table indicating kinds of winning combinations and payouts corresponding thereto (see FIGS. 8 and 9), and various effects on the game. On the other hand, the lower display 4 displays a number of variable display portions (for example, nine variable display portions) 22A to 22C, 23A to 23C, and 24A to 24C shown in FIG. 2. The lower display 4 displays a number of pay lines “L1” to “L8” (for example, eight pay lines) as shown in FIG. 3. Here, in each of the variable display portions 22A to 22C, 23A to 23C, and 24A to 24C, variable displays may be displayed as part or all of a video reel 100. That is, various kinds of symbols to form the video reel 100 (see FIG. 7) are displayed while being scrolled from the right to the left (or scrolling in other directions) in each of the display portions 22A to 22C, 23A to 23C, and 24A to 24C. Other types of displays may be used to display the display portions 22A to 22C, 23A to 23C, and 24A to 24C including but not limited to flashing, fading, wiping, and other transition techniques.

An operation table 5 formed by projecting to proximal side is provided at the bottom of the lower display 4. A CHANGE button 6, a CASHOUT button 7, and a HELP button 8 are arranged on the operation table 5 (for instance, arranged on the left side). A coin insertion slot 9 and a bill insertion portion 10 may be located to the right of the HELP button 8. A 1-BET button 11, a SPIN/REPEAT BET button 12, a 3-BET button 13, a 5-BET button 14, and an 8-BET button 15 may be arranged on the forward part of the operation table 5.

The CHANGE button 6 is a button to be pressed when the bill inserted in the bill insertion portion 10 is to be returned to a player in the form of one or more coins. Changed coins dispensed on the basis of a press operation of the CHANGE button 6 are paid out through a coin payout opening 16 to a coin tray 17, which may be formed at the lower part of the cabinet 2. A CHANGE switch 62, which will be described later, may be attached to the CHANGE button 6.

After a game has ended, the CASHOUT button 7 is pressed to retrieve the player's remaining coins. When the CASHOUT button 7 is pressed, coins won in games are paid out through the coin payout opening 16 to the coin tray 16. A CASHOUT switch 63, which will be described later, is attached to the CASHOUT button 7.

The HELP button 8 is a button to be pressed when a player cannot understand game operation method. When the HELP button 8 is pressed, various help information is displayed on the upper display 3. A HELP switch 64, which will be described later, is attached to the HELP button 8.

A coin sensor 65, which will be described later, is arranged in relation to the coin insertion slot 9. When the coin (s) is inserted in the coin insertion slot 9, the coin sensor 65 detects coin (s) inserted and a coin detection signal, which is generated from the coin sensor 65, may be output to the CPU 50 (see FIG. 4). A bill sensor 66, which will be described later, is arranged in relation to the bill insertion portion 10. When the bill is inserted in the bill insertion portion 10, a bill detection signal, which is generated from the bill sensor 66, may be output to the CPU 50 (see FIG. 4).

The 1-BET button 11 is a button to bet one bet every press of the 1-BET button 11. A 1-BET switch 58 is attached to the 1-BET button 11. In the slot machine 1 according to one or more illustrative embodiments, all pay lines “L1” to “L8” can be activated on the basis of one bet.

A SPIN/REPEAT BET button 12 is a button to start the game with the present bet number or the previous bet number on the basis of a press of the button 12. If the SPIN/REPEAT BET button 12 is pressed, variably display of the symbols in each of the variable display portions 22A to 22C, 23A to 23C, and 24A to 24C will start. A spin switch 57, which will be described later, is attached to the SPIN/REPEAT BET button 12. Here, in one or more embodiments, the bet number, which can be betted by pressing of the SPIN/REPEAT BET button 12 can be any value including but not limited to one, two, three, five, or eight.

The 3-BET button 13, the 5-BET button 14, and the 8-BET button 15 are buttons to bet three, five, and eight bets on the basis of a press operation thereof. A 3-BET switch 59, a 5-BET switch 60, and an 8-BET switch 61 are attached to the 3-BET button 13, the 5-BET button 14, and the 8-BET button 15, respectively.

The coin payout opening 16 and the coin tray 17 may be formed at a lower position of the cabinet 2. The coin payout opening 16 is the portion in which coin (s) is paid on the basis of press operation of the CHANGE button 6 or the CASHOUT button 7. The coin tray 17 is the portion for receiving coins paid out from the coin payout opening 16. The coin detection portion 73, which is constructed from the sensor etc., is arranged inside the coin payout opening 16. The coin detection portion 73 detects the number of coins paid out from the coin payout opening 16 (see FIG. 4).

Next, the construction of the control system in the slot machine 1 will be described with reference to FIG. 4. FIG. 4 is a block diagram schematically showing the control system in the slot machine 1. As shown in FIG. 4, the control system in the slot machine 1 may be constructed from a CPU 50 as a core. A ROM 51 and a RAM 52 are connected to the CPU 50. In the ROM 51, various programs for controlling the slot machine 1 and data tables are stored. For example, various control programs including a main process program, which will be described later and various data tables (including a lottery table associating a value of a random number and a symbol to be displayed) may be stored in the ROM 51.

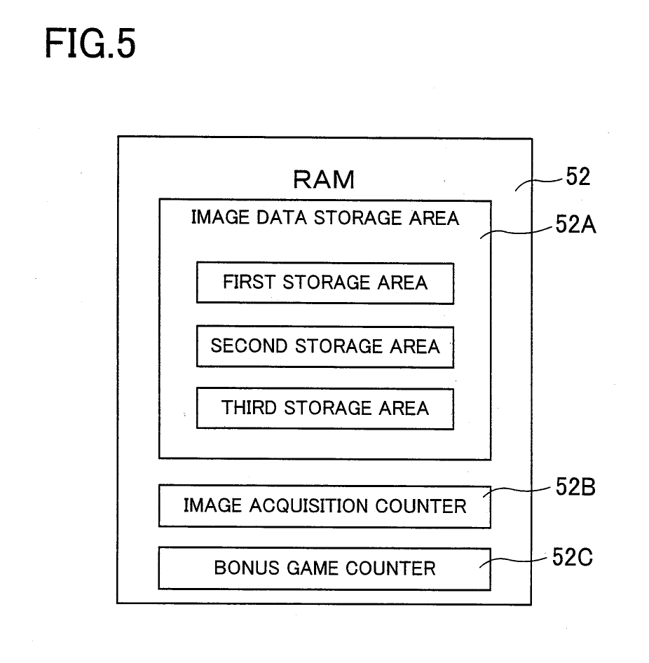

The RAM 52 is a temporary memory for storing various data processed by the CPU 50. Here, in the RAM 52 of the slot machine 1 according to one or more illustrative embodiments, as shown in FIG. 5, an image data storage area 52A, an image acquisition counter 52B, and a bonus game counter 52C are formed. Here, the number of storage areas is variable. The image data storage area 52A is the storage area in which partial image data acquired in a partial image data acquisition process (S9), which will be described later, is stored. Here, the partial image data is the data corresponding to part of the display pattern displayed on the lower display 4. In the image data storage area 52A, the first storage area to the third storage area are formed, and in each storage area, partial image data acquired in the partial image data acquisition process (S9) is stored. Here, the number of storage area is variable. In addition, the partial image data stored in the image data storage area 52A is used when the composite image data (including the partial composite data and the whole composite image data which will be described later) is generated during the game process (S7), and at this point, it will be described in detail later. In the slot machine 1, the awarding of the special award is determined based on the combination of the symbols corresponding to generated composite image data. The image acquisition counter 52B is the storage to count the number of the times in which the partial image data is acquired in the partial image data acquisition process (S9). In one or more embodiments, the partial image data are acquired so that the composite image data corresponding to the whole of the lower display 4 (hereinafter “the whole composite image data”) is generated by been executed the partial image data acquisition process (S9) three times (for instance), and at this point, it will be described in detail later. Here, the execution number of times is variable. That is, the image acquisition counter 52B also functions the counter indicating the storage condition of partial image data in the image data storage area 52A. The bonus counter 52C is the storage to count the number of the times of the bonus game in the bonus game process (S11) which will be described later. In the slot machine 1 in one or more embodiments, the free game is executed predetermined times (for example, five times) as the bonus game, so the bonus game may be finished based on the value of the bonus game counter 52C.

A clock pulse generator 53 for generating standard clock pulses and a frequency divider 54 are connected to the CPU 50. Further, a random number sampling circuit 56 for generating random numbers are connected to the CPU 50. Here, the random numbers sampled by the random number sampling circuit 56 is used in various lotteries including the winning combinations. Further, switches attached every button on the operation table 5 are attached, respectively. That is, a SPIN/REPEAT switch 57, a 1-BET switch 58, a 3-BET switch 59, a 5-BET switch 60, an 8-BET switch 61, a CHANGE switch 62, a CASHOUT switch 63, and a HELP switch 64 are connected to the CPU 50, respectively. If the CPU 50 receives the switch signal output from each switch on the basis of press operation thereof, the CPU 50 will control various operations corresponding to the button in which the switch signal from thereof received.

Further, a coin sensor 65 and a bill sensor 66 are connected to the CPU 50, respectively. The coin sensor 65 detects coins inserted from the coin insertion slot 9. Herewith, the CPU 50 can calculate the number of inserted coins based on the coin detection signal output from the coin sensor 65. The bill sensor 66 detects the kind and sum of the bill inserted from bill insertion portion. The CPU 50 calculates the number of coins equal to the sum of bill based on that bill detection signal.

A hopper 71 is connected through a hopper drive circuit 7 to the CPU 50. If a drive signal, which is generated from the CPU 50, is output to the hopper drive circuit 70, the hopper 71 will pay out a predetermined number of coins from the coin payout opening 16. A coin detection portion 73 arranged in the coin payout opening 16 is connected to the CPU 50 through the payout completion signal circuit 72. If the coin detection portion 73 detects that a predetermined number of coins are paid out from the coin payout opening 16, a coin payout detection signal will be output to the payout completion signal circuit 72. The payout completion signal circuit 72 outputs a payout completion signal to the CPU 50 based on the coin payout detection signal. Further, the upper display 3 and the lower display 4 are connected through the display drive circuit 74 to the CPU 50. Hence, the display contents of the upper display 3 and the lower display 4 are controlled by the CPU 50, respectively. When the procedure is shifted to the partial image data acquisition process (S9) which will be described later, the display drive circuit 74 generates the partial image data corresponding to the split pattern data which will be described later based on the display pattern displayed on the lower display 4 (the combination of the symbols stopped and displayed in each of the variable display 22A to 22C, 23A to 23C, and 24A to 24C) and outputs to the CPU 50. Here, the partial image data output is stored in each of the storage area (the first storage area to the third storage area) of the image data storage area 52A.

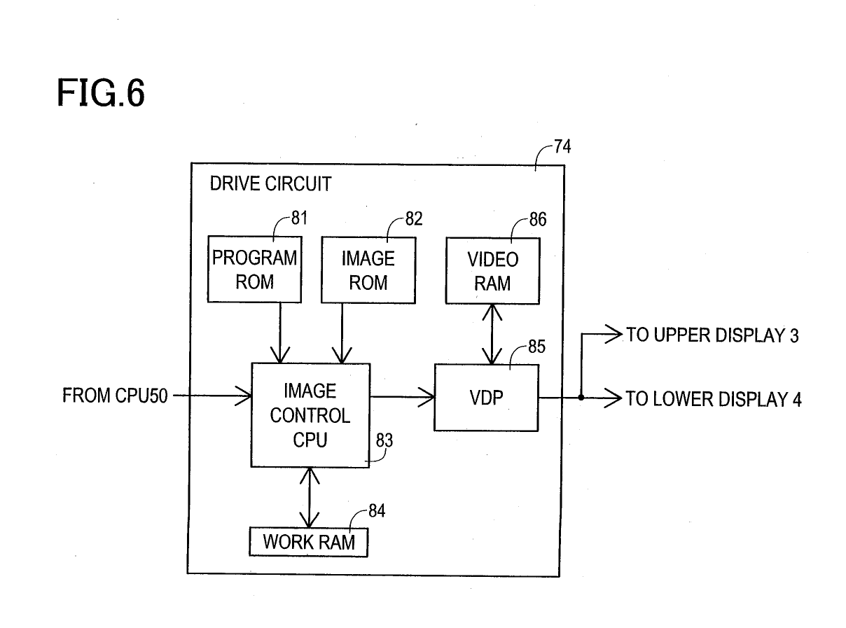

As shown in FIG. 6, the display drive circuit 74 may include a program ROM 81, an image ROM 82, an image control CPU 83, a work RAM 84, a VDP (video display processor) 85, and a video RAM 86. An image control program related to the display on the upper display 3 and the lower display 4, and various selection tables are stored in the program ROM 81. The image data to form images, for example, various images of the demonstration effects conducted on the lower display 3 and upper display 4 and the help information and the payout table displayed on the upper display 3 are stored in the image ROM 82. Here, in the image ROM 82, the image data to form the symbols displayed in the variable display portions 22A to 22C, 23A to 23C, and 24A to 24C (see FIG. 2) on the lower display 4 are also stored. The symbols displayed in the variable display portions 22A to 22C, 23A to 23C, and 24A to 24C will be described later. The image control CPU 83 determines the images displayed on the upper display 3 and the lower display 4 from the image data stored beforehand in the image ROM 82 according to the image control program stored beforehand in the program ROM 81 based on parameters set by the CPU 50. The work RAM 84 functions as a temporary memory when the image control program is executed in the image control CPU 83. The VDP 85 forms images corresponding to display contents determined by the image control CPU 83, and the VDP 85 outputs the images formed thereby to the upper display 3 and the lower display 4. Thereby, for example, each of the symbols is variably displayed for a predetermined time, and then, stopped in the variable display portions 22A to 22C, 23A to 23C, and 24A to 24C on the lower display 4. The video RAM 86 functions as a temporary memory when the images are formed by the VDP 85.

The touch panel 201 is connected through a touch panel drive circuit 202 to the CPU 50. As mentioned above, the touch panel 201 is arranged on the image screen of the lower display 4. The CPU 50 can recognize the place where the player touches based on the coordinate information of the portion touched by the player based on the touch panel drive circuit 202.

LEDs 78 are connected through a LED drive circuit 77 to the CPU 50. Many LEDs 78 are arranged on the front face of the slot machine 1, and are controlled by the LED drive circuit 77. LEDs 78 are controlled based on the drive signal from the CPU 50 when various effects are produced. A sound output circuit 79 and a speaker 80 are connected to the CPU 50. The speaker 80 reproduces various effect sounds when various effects are produced based on the output signal from the sound output circuit 79.

Next, the symbols used in the game of the slot machine 1 will be described. FIG. 7 is a view showing a symbol row (video reel), which is variably displayed while being scrolled in each of the variable display portions 22A to 22C, 23A to 23C, and 24A to 24C. Here, the video reel 100 is constructed from the symbol row constructed from various symbols. For the purposes of explanation, the various symbols may include “WILD” 101, “BLU7” 102, “RED7” 103, “BAR” 104, “EIGHT” 105, “BELL” 106, “WATERMELLON” 107, “PLUM” 108, “ORANGE” 109, “CHERRY” 110, and “BLANK” 111. Here, kinds of symbols are variable. And, the number of symbols is variable.

As mentioned above, in the slot machine 1, in the variable display portions 22A to 22C, 23A to 23C, and 24A to 24C (for instance, nine), the symbols are variable displayed by the video reel 100, and one symbol is stopped and displayed in each of the variable display when the predetermined time elapses. Here, the lottery table, which is used when the symbols stopped and displayed in each of the variable display portions 22A to 22C, 23A to 23C, and 24A to 24C are determined, will be described with reference to FIG. 8 FIG. 8 is an explanatory view showing the lottery table of the stopped and displayed symbols used when the game is performed by using variable display portions. Here, the lottery table shown in FIG. 7 is stored in the ROM 51.

Stopped and displayed symbols in each of the variable display portions 22A to 22C, 23A to 23C, and 24A to 24C are determined every each variable display portion 22A to 22C, 23A to 23C, and 24A to 24C. Therefore, a code number, which lies in a range of “0” to “10” for instance, is allotted to each of the symbols (“WILD” 101, “BLU7” 102, “RED7” 103, “BAR” 104, “EIGHT” 105, “BELL” 106, “WATERMELLON” 107, “PLUM” 108, “ORANGE” 109, “CHERRY” 110, and “BLANK” 111, for instance) to form the video reel 100 (see FIG. 7). The lottery table (see FIG. 8) in which each of the code numbers is set for the range of the random number value is stored in the ROM 51. Further, nine random number values are sampled by the random number sampling circuit 56 so as to correspond to each of the variable display portions 22A to 22C, 23A to 23C, and 24A to 24C. At a result, the symbols which are stopped and displayed in each of the variable display portions 22A to 22C, 23A to 23C, and 24A to 24C are determined based on the code numbers.

It will be specifically described in this point. For example, in a case where the random number is sampled for each of the symbols to form the video reel 100 in the variable display portion 23A through the random number sampling circuit 56, if the random number value lies in a range of 0 to 1, the code number of the variable display portion 23A will be “0” based on the lottery table (see FIG. 8). Thereby, the symbol in which stopped and displayed in the variable display portion 23A is the symbol “WILD” 101 corresponding to the code number “0”. Thereby, when scrolled display executed in a predetermined time is finished, the symbol “WILD” symbol 101 is stopped and displayed in the variable display portion 23A. Below, each of the code numbers “1” to “9” is processed in the same way based on the symbol lottery table (see FIG. 8). Here, the stopped and displayed symbol will be determined as well as each other symbol to form the video reel 100 in the variable display portion 22A.

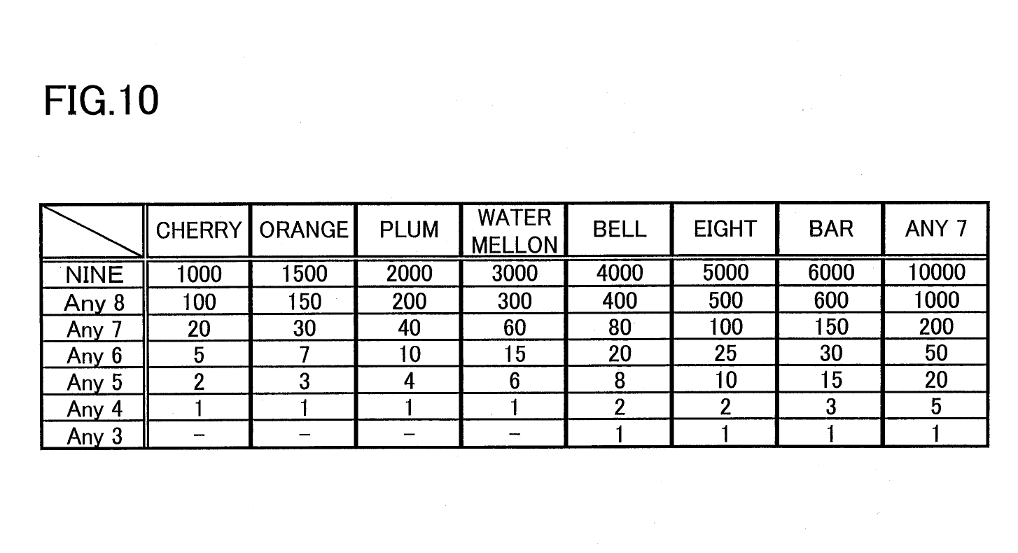

Next, the winning combinations and the payouts thereof in the slot machine 1 will be described with reference to FIGS. 9 and 10. FIG. 9 is an explanatory view showing the payout table indicating the line odds winning combinations and the payouts thereof. As shown in FIG. 9, the line odds payout table holds a payout number in which the symbols stopped and displayed in three display portions (see FIG. 2) on some activated pay line among each of the activated pay lines (see FIG. 3) on the lower display 4 are predetermined combination. For example, concerning the variable display portions 22A to 22C, 23A to 23C, and 24A to 24C, if all code numbers for the variable display portions (for example, variable display portion 22A to 22C) on some pay line (for example, pay line L1) among pay lines are any of “2” to “19”, “BLUE7-BLUE7-BLUE7” is won (see FIG. 9) for this pay line. In this case, all code numbers of variable display portion on that pay lines are “2”, and the symbol “BLUE7” 102 is stopped and displayed in that variable portions (see FIG. 8). The payout number “30” will be acquired to the player. Here, the payout number is variable. In a case where there exists plural pay lines for each of which “BLUE7-BLUE7-BLUE7” is won, the payout number calculated by multiplying the number of pay lines by “30” (for instance) will be obtained. Similarly to this, each payout number of line odds will be determined based on the payout table of the line odds as shown in FIG. 9.

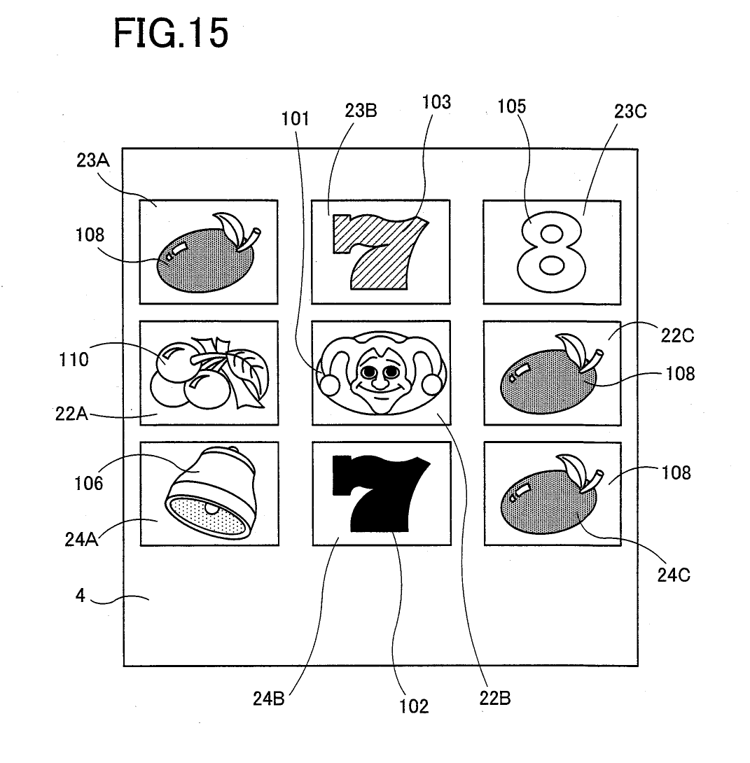

Here, essentially, if all symbols stopped and displayed in three variable display portions on some activated pay line are same, the line odds winning combination is won, and in one or more embodiments, even though all symbols stopped and displayed in three variable display portions are not same, the line odds winning combination may be won. For example, in the winning combination “BLUE7-RED7-ANY” as shown in FIG. 9, if the symbols stopped and displayed in two variable display portions among three variable display portions on some activated pay line are “BLUE7” 102 and “RED7” 103, above winning combination will be won even though the symbol stopped and displayed in the rest of the variable display portion is any of symbols (“WILD” 101 to “BLANK” 111). In this case, the payout number “10” will be acquired based on the winning combination “BLUE7-BLUE7-BLUE7” (see FIG. 9). If the symbol stopped and displayed in the variable display portion 22B is “WILD” 101, the outcome “CENTERED WILD” will be won and the payout number “1” will be acquired (for example, see FIG. 15). Here, in this case, the award in which the bonus game process (S11) can be executed, which will be described later, will be also acquired. In the bonus game process (S11) shifted at this time, the free game in which the game conducted predetermined times (five times) without consumption of credit. In above free game, while “WILD” 101 is stopped and displayed in the variable display portion 22B, the game, in which the variably and stopped displays are performed in other eight variable display portions, is conducted. The bonus game process (S11) will be described in detail later.

And, “WILD” 101 is the wild card which can be regarded other any symbol (for example, “BLUE7” 102 to “CHERRY” 110). Thereby, if “WILD” 101 is displayed in any of the variable display portions on some pay line, the combination of other variable display portions fit the combination shown in FIG. 9, the line odds will be won. For example, when “WILD” 101 is stopped and displayed in variable display portion 22C out of variable portions from 22A to 22C, if the symbols stopped and displayed in the variable display portions 22A and 22B are “WATER MELLON” 107, the winning combination “WATER MELLON” will be won.

In addition, in one or more embodiments, the line odds winning combination is set to the condition shown in FIG. 9, however, the winning combination not shown in FIG. 9 can be set as the winning combination. For example, above winning combination “BLUE7-RED7-ANY” can be replaced by winning combination “ANY3 of 7. In this winning combination “ANY-3 of 7”, all symbols stopped and displayed in the three variable display portions on some pay line are “BLUE7” 102 or “RED7” 103, above winning combination will be won.

In one or more embodiments, the payout will awarded on the basis of the number of same symbols (including “WILD” 101) stopped and displayed in each of the variable display portions (see FIG. 2) on each of the activated pay lines (see FIG. 3) on the lower display 4. In the any odds payout table as shown in FIG. 10, the payout number acquired in this case is set based on the symbols and the number of the same symbols. For example, if five sampled random values corresponding to five variable display portions among nine variable display portions 22A to 22C, 23A to 23C, and 24A to 24C lie in a range of random value “65” to “78”, “ANY-5 of PLUM” will be won. In this case, five code numbers corresponding to five variable display portions among nine variable display portions 22A to 22C, 23A to 23C, and 24A to 24C are “7” (see FIG. 8) and “PLUM”s 108 are stopped and displayed respectively. The payout number “4” corresponding to the winning combination “ANY-5 of PLUM” is acquired for the player based on the random result (see FIG. 10). The payout number corresponding to other winning combination of the any odds are acquired based on the any odds payout table as shown in FIG. 10 in the same way. In addition, in this case, “WILD” 101 also functions as the wild card. That is, in nine variable display portion, if “WILD” 101 and four “PLUM”s 108 are stopped and displayed, as mentioned above, “ANY-5 of PLUM” will be won and the payout number “4” corresponding to the winning combination “ANY5 of PLUM” is acquired for the player.

Here, in the slot machine 1 in one or more embodiments, all pay lines (for instance, all eight pay line) are activated with one bet, so with respect to the variable display portions 22A to 22C, 23A to 23C, and 24A to 24C, it requires that five variable display portions are the same. However, in one or more embodiments in which activated pay lines are variable based on the bet number, it is determined whether any odds win based on the number of the same symbols in the symbols displayed in the variable display portions corresponding to the activated pay lines.

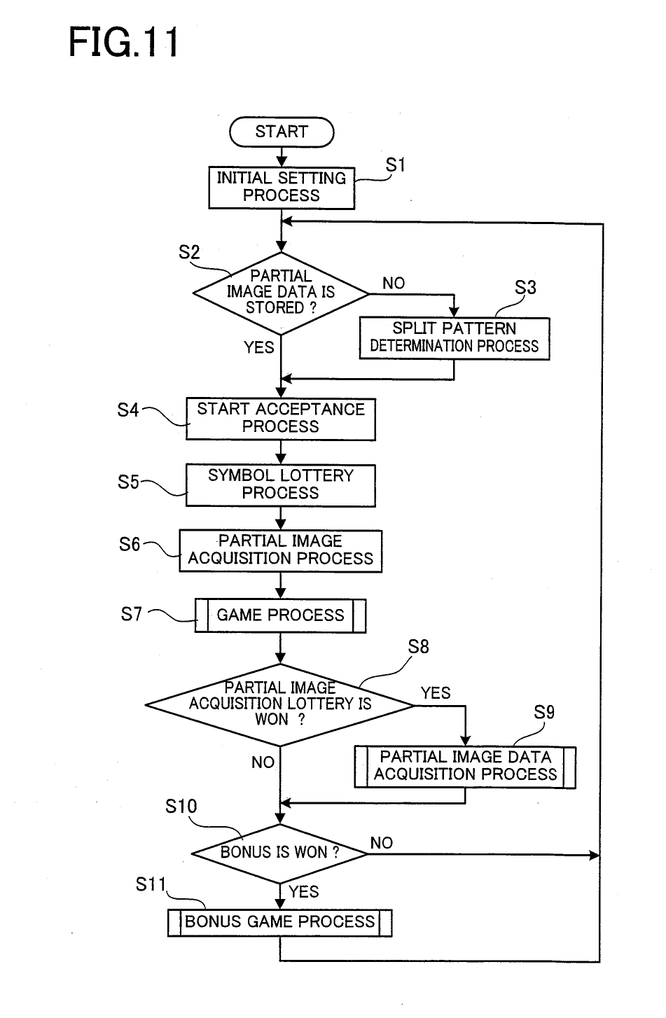

Next, the main process program executed in the slot machine 1 in one or more embodiments will be described with reference to FIG. 11. FIG. 11 is a flowchart of the main process program. As shown FIG. 11, when the main process program is executed, at first, in S1, the CPU 50 executes the initial setting process. In the initial setting process (S1), the initial settings such as reset for each of the storage area of the RAM 52 and the counter value are performed. After various initial settings are performed, the CPU will shift the procedure to S2.

When the procedure is shifted to S2, the CPU 50 determines whether the partial image data is stored in the image data storage area 52A. Concretely, the CPU 50 determines based on whether the value of the image acquisition counter 52B is “0” by referring the image acquisition counter 52B. Here, if the whole composite image is generated with the use of the partial image data stored in the first storage area to the third storage area, the image acquisition counter 52B will be set to “0” (S57). At this time, all partial image data stored in the image data storage area 52A will be erased, at a result, the value of the image acquisition counter 52B “0” indicates the condition where none of the partial image data is not stored in the image data storage area 52A. If the partial image data is stored in the image data storage area 52A (S2:YES), the CPU 50 will shift the procedure to the start acceptance process (S4) directly. On the other hand, if the partial image data is not stored in the image data storage area 52A (S2:NO), the CPU 50 will shift the procedure to the split pattern determination process (S3).

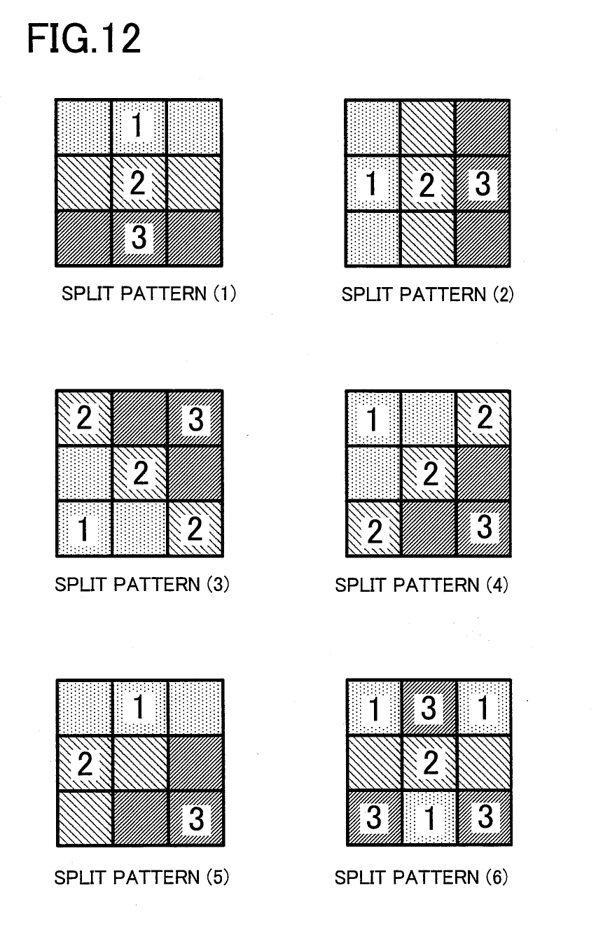

In S3, the CPU 50 executes the split pattern determination process. Here, the split pattern data determined in the split pattern determination process (S3) will be described in detail with reference to the drawings. FIG. 12 is the explanatory view showing the pattern of the split pattern data in one or more embodiments. The split pattern data determined in the split pattern determination process (S3) is the data which will be employed in the partial image data acquisition process (S9) (which will be described later). The split pattern data identifies the patterns of the partial image data acquired in the partial image data acquisition process (S9) and the sequence in which the partial image data is acquired. An illustrative sequence identifies “the portion acquired in the first partial image data acquisition process (S9)”, “the portion acquired in the second partial image data acquisition process (S9)”, and “the portion acquired in the third process (S9)” for the image displayed on the lower display 4. In the partial image data acquisition process (S9), which will be described later, the partial image (s) displayed on the lower display 4 at this point is acquired based on the split pattern data and an image acquisition counter 52B, which will be described later. Thereby, the whole composite image data is generated from three partial images on the lower display 4 by executing the partial image data acquisition process (S9) during three separate times, e.g. games. For example, in the case of the “split pattern (5)” as shown in FIG. 12, the “split pattern (5)” is set so that, if the partial image data acquisition process (S9) is executed a first time, the partial image data constructed from the partial images displayed in the three variable display portions 23A to 23C will be acquired, if the partial image data acquisition process (S9) is executed a second time, the partial image data constructed from the partial images displayed in the three variable display portions 22A, 22B, and 24A will be acquired, and if the partial image data acquisition process (S9) is executed a third time, the partial image data constructed from the partial images displayed in the three variable display portions 22C, 24B, and 24C will be acquired. At the result, the whole composite image data including the partial images displayed in the nine variable display portions 22A to 22C, 23A to 23C, and 24A to 24C can be acquired without acquiring overlapping images by acquiring the partial image data three times based on the split image data. In addition, the “split pattern (1)” to the “split pattern (4)”, and the “split pattern (6)” are set three split image data acquisition pattern which is difference from the “split pattern (5)”. Here, as shown in FIG. 12, the whole composite image data including the partial images displayed in the nine variable display portions 22A to 22C, 23A to 23C, and 24A to 24C can be acquired by executing the partial image data acquisition process (S9) three times in the case of any of the “split pattern (1)” to the “split pattern (6)”. Here, the partial images displayed in the variable display portions may be a set of symbols including one or more of the displayed symbols.

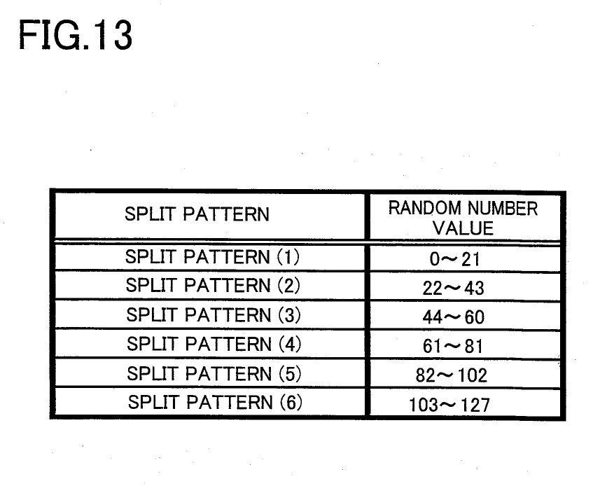

In the split pattern determination process (S3), the CPU 50 determines one split pattern out of “split pattern (1)” to “split pattern (6)” randomly. Concretely, the CPU 50 determines the split pattern which is used based on the split pattern lottery table (see FIG. 13) and the random number value sampled by the random sampling circuit 56. As shown in FIG. 13, in the split pattern lottery table, the range of the random number value is set as to correspond to “split pattern (1)” to “split pattern (6)” respectively. Thereby, in the split pattern determination process (S3), the CPU 50 determines the split pattern based on the range which the random number value sampled by the random number sampling circuit 56 lies thereon. For example, if the random number value sampled by the random number sampling circuit 56 lies on the range from “61” to “81”, it is determined that the split pattern which is used is “split pattern (4)”. In this way, if the split pattern used is determined randomly, the CPU 50 will shift the procedure to the start acceptance process (S4).

When the procedure is shifted to S4, the CPU executes the start acceptance process. In the start acceptance process, the game, which the bet value at one game is determined and the game is started, is executed. Concretely, the CPU 50 displays activated pay lines on the lower display 4 based on the switch signal from operated button (namely, the start signal) when the 1-BET button 11, the SPIN/REPEAT BET button 12, the 3-BET button 13, the 5-BET button 14, or the 8-BET button 15 (hereinafter “1-BET button or the like” as a generic term of above buttons) is operated. In this time, the line odds payout table (see FIG. 9) and the any odds payout table (see FIG. 10) are displayed on the upper display 3. The CPU 50 stores the bet number value, which is bet on the basis of a press operation of the 1-BET button of the like, in the RAM 52, and shifts the procedure to the symbol lottery process (S5).

When the procedure is shifted to the symbol lottery process (S5), the CPU 50 determines the symbols to be stopped and displayed in each of the variable display portions 22A to 22C, 23A to 23C, and 24A to 24C, and executes the process, which the winning combination in the game is determined. Concretely, the CPU 50 determines nine random values in a range of “0” to “127” (for instance) corresponding to each of the variable display portions 22A to 22C, 23A to 23C, and 24A to 24C through the random number sampling circuit 56. The CPU 50 determines the stopped and displayed symbols based on the sampled random number values and the lottery table (see FIG. 8) via the code numbers. In the symbol lottery process (S5), after nine stopped and displayed symbols are determined, the CPU 50 stores the random result in the RAM 52, and the procedure is shifted to the partial image acquisition lottery process (S6).

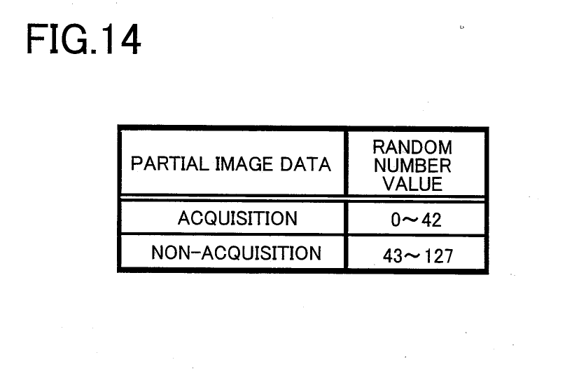

In S6, the CPU 50 executes the partial image acquisition lottery process. In the partial image acquisition lottery process (S6), the CPU 50 determines whether the partial image data acquisition process, which will be described later, can be executed by randomly. Concretely, the CPU 50 determines one random value in a range of “0” to “127” through the random number sampling circuit 56. The CPU 50 determines whether the partial image data acquisition process (S9) can be executed based on the random number value and the partial image acquisition lottery table (see FIG. 14). For example, the random number value sampled by the random number sampling circuit 56 lies in a range of “0” to “42”, the CPU 50 determines that the partial image acquisition lottery is won (namely, the execution of the partial image data acquisition process (S9) is allowed). After the random result in the partial image acquisition lottery process is stored in the RAM 52, the CPU 50 shifts the procedure to the game process (S7).

When the procedure is shifted to S7, the CPU 50 executes the game process. In this game process (S7), the CPU 50 variably displays video reel 100 in each of the variable display portions 22A to 22C, 23A to 23C, and 24A to 24C, and after the predetermined time elapsed, the symbol is stopped and displayed based on the random result of the symbol lottery process (S5). After the symbol stopped and displayed, the payouts will be awarded based on the combination of the stopped and displayed symbols (the line odds winning combination and the any odds winning combination). In this time, if the partial image data is stored, the composite image (the partial composite image or the whole composite image which will be described later) will be generated, and the special award will be awarded based on the combination of symbol corresponding to above composite image data. After the award and the special award are awarded, the CPU 50 will be shift the procedure to S8. Here, the game process (S7) will be described with reference to the drawing in detail later.

In S8, the CPU 50 determined whether the partial image acquisition lottery is won by reading the random result of the partial image acquisition lottery process (S6). If the partial image acquisition lottery is won (S8:YES), the CPU 50 will shift the procedure to the partial image data acquisition process (S9). On the other hand, the partial image acquisition lottery is not won (S8:NO), the CPU 50 will shift the procedure to S10 directly.

When the procedure is shifted to the partial image data acquisition process (S9), the CPU 50 stores the part of the display contents displayed on the lower display 4 in the storage areas (the first storage area to the third storage area) of the image data storage area 52A, as the partial image data. After the partial image data stored in the image data storage area, the CPU 50 finishes the partial image data acquisition process (S9), and shifts the procedure to S10. The partial image data acquisition process (S9) will be described in detail with reference to the drawings later.

In S10, the CPU 50 determines whether the bonus game is won in the game executed in S4 to S7. That is, the CPU 50 determines whether the symbol is “WILD” 101 on the basis of the result of the symbol lottery process (S5). If “WILD” symbols 101 is stopped and displayed (see FIG. 15), namely the bonus game is won (S10:YES), the CPU 50 will shift the procedure to the bonus game process (S11). On the other hand, if the symbol is other than “WILD” symbol 101 (for example, “BLUE7” 102 to “BLANK” 111) (S10:NO), the CPU 50 will return the procedure to S2.

When the procedure is shifted to S11, the CPU 50 executes the bonus game process. In the bonus game process (S11), the free game is performed predetermined times (for example, five times). In the free game, while “WILD” 101 is fix-displayed in the variable display portion 22B, the lotteries of eight other variable display portions are conducted. When the free game is finished the predetermined times, the CPU 50 finishes the bonus game process (S11), and shifts the procedure to S2.

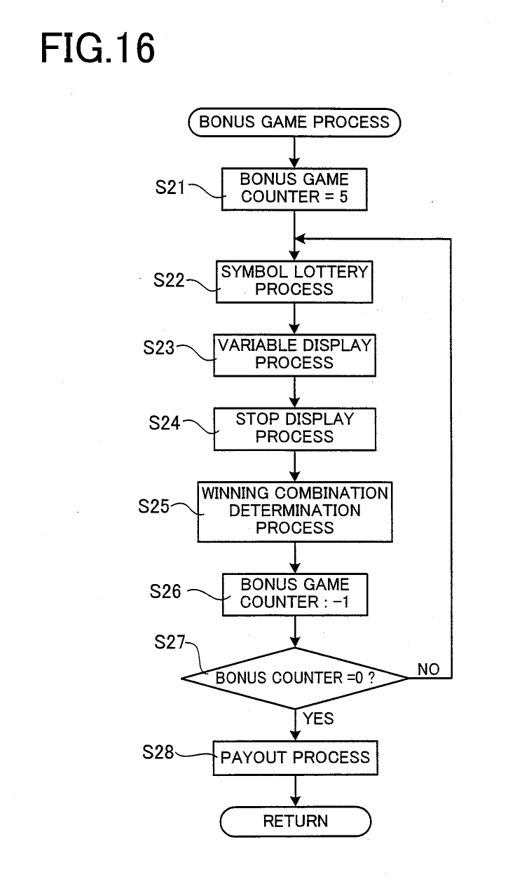

Here, the bonus game process program executed in the bonus game process (S11) will be described in detail with reference to the drawings. FIG. 16 is a flowchart of the bonus game process program. If “WILD” symbol 101 is stopped and displayed in the variable display portion 22B (S10:YES) and the procedure is shifted to the bonus game process (S11), at first, the CPU 50 sets the value of the bonus game counter to “5” (S21). After the value of the bonus game counter is set to “5”, the CPU 50 will shift the procedure to S22.

Next, the symbol lottery process (S22) is the same as the symbol lottery process (S5) in the main process program, hence, the explanation for that will be omitted. After the symbol lottery process (S22) is executed, the CPU 50 shifts the procedure to S23. Here, in the symbol lottery process (S22), the random for the symbol corresponding to the variable display portion 22B is not conducted and the random for the symbols corresponding to eight other variable display portions (the variable display portions 22A, 22C, 23A to 23C, and 24A to 24C) are conducted. At the result, the game is performed while the “WILD” 101 is fix-displayed in the variable display portion 22B, so the winning probability of the winning combination may increase. That is, if the procedure is shifted to the bonus game, the player can anticipate that higher payouts will be provided.

In S23, the CPU 50 variable displays the video reel 100 in the variable display portions 22A, 22C, 23A to 23C, and 24A to 24C. Herewith, in the variable display portions 22A, 22C, 23A to 23C, and 24A to 24C, each of the video reel 100 is variable displayed while being scrolled from the top to the bottom. If the predetermined time elapsed since variable display starts, the CPU 50 will stop and display each of the symbol in the variable display respectively (S24). After the stop and display process (S24), the CPU 50 shifts the procedure to S25.

In S25, the CPU 50 executes the winning determination process, in which the winning combination and the award contents corresponding thereto are determined, based on the symbols stopped and displayed in the variable display portions 22A to 22C, 23A to 23C, and 24A to 24C. Concretely, the CPU 50 determines the winning combination (including the any odds winning combination and the line odds winning combination) and the payouts in this game based on the symbol stopped and displayed in the each of the variable display portions and the payout table (see FIGS. 9 and 10). For example, in the case of the concrete example shown in FIG. 15, the winning combination “BLUE7-RED7-ANY”, the winning combination “PLAM”, and the winning combination “CENTERED WILD” are realized as the line odds winning combination. The winning combination of “ANY-4 of PLUM” and “ANY-3 of ANY7” are realized as the any odds winning combination (see FIG. 10). Thereby, in the case of the result of the random shown in FIG. 15, the sum of the payouts “14” corresponding to line odds and any odds which are realized is stored in RAM 52 as the payout. After the payout based on the random result is stored in RAM 52, the CPU 50 shifts the procedure to S26.

When the procedure is shifted to S26, the CPU 50 subtracts “1” from the value of the bonus game counter 52C. After the value of the bonus game counter 52C is subtracted, the CPU 50 determines whether the value of the bonus game counter 52C is “0” (S27). If the value of the bonus game counter 52C is “0” (S27:YES), the CPU 50 will shift the procedure to S28. On the other hand, if the value of the bonus game counter 52C is not “0” (S27:NO), the CPU 50 will return the procedure to S28. Herewith, the process of S22 to S27 is repeated until the value of the bonus game counter 52C reaches “0”, in the result, favorable game is repeatedly executed the predetermined times (for example, five times).

After the free games are executed predetermined times (for example, five times) (S27:YES), when the procedure is shifted to S28, the CPU 50 calculates the sum of the payouts, and the summed payout is paid to the player. After the payout is paid, the CPU finishes the bonus game process (S11).

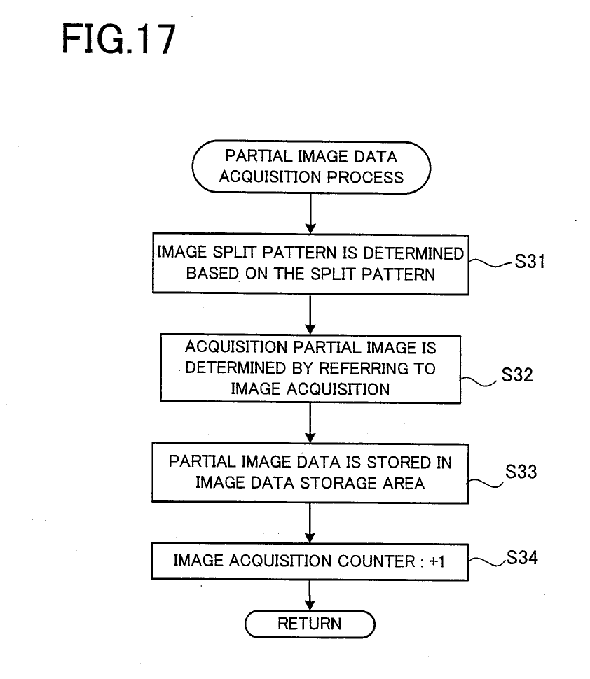

Next, the partial image data acquisition process program executed in S9 of the main process program will be described in detail with reference to the drawings. FIG. 17 is a flowchart of the partial image data acquisition process program. As shown in FIG. 17, if the procedure is shifted to the partial image data acquisition process (S9) based on the random result of the partial image acquisition lottery process (S6), the CPU 50 will determine the split pattern of the image displayed on the lower display 4 by reading the split pattern data determined split pattern determination process (S3) from the RAM 52. For example, if the “split pattern (3)” is set, the split pattern is determined based on the split pattern data so as to current display contents displayed on the lower display 4 is constructed from “the partial images displayed in the variable display portions 22A, 24A, and 24B”, “the partial images displayed in the variable display portions 23A, 22B, and 24C”, and “the partial images displayed in the variable display portions 23B, 23C, and 22C.

Next, the procedure is shifted to S32, the CPU 50 determines the acquired image based on the value of the image acquisition counter 52B and the split pattern determined in S31. In the case of above example, if the value of the image acquisition counter 52B is “0”, the CPU 50 determines that the partial image data constructed from the partial images displayed in the variable display portions 22A, 24A, and 24B is acquired. If the value of the image acquisition counter 52B is “1”, the CPU 50 determines that the partial image data constructed from the partial images displayed in the variable display portions 23A, 22B, and 24C is acquired. If the value of the image acquisition counter 52B is “2”, the CPU 50 determines that the partial image data constructed from the partial images displayed in the variable display portions 23B, 23C, and 22C is acquired.

In S33, the CPU 50 acquires the partial image data determined in S31, S32 through the display drive circuit 74. Furthermore, the CPU 50 stores above partial image data in the storage areas (the first storage area to the third storage area) of the image data storage area 52A. In this time, the CPU 50 refers to the value of the image acquisition counter 52B. After that, the CPU 50 determines the storage area in which the partial image data to be stored based on the counter value. Concretely, for example, in one of more embodiments, if the value of the image acquisition counter 52B is “0”, the partial image data will be stored in the first storage area of the image data storage area 52A. If the value of the image acquisition counter 52B is “1”, the partial image data will be stored in the second storage area of the image data storage area 52B. If the value of the image acquisition counter 52B is “2”, the partial image data will be stored in the third storage area of the image data storage area 52C.

After the partial image data is acquired based on the value of the image acquisition counter 52B and the split pattern data, the CPU 50 adds “1” to the value of the image acquisition counter 52B (S34). By this means, the image acquisition counter 52B is added to “1” every time the partial image data is acquired, so the value of the image acquisition counter 52B corresponds to the amount of the partial image data stored in the image data storage area 52A. After the value of the image acquisition counter 52B is added to “1”, the CPU 50 finishes the partial image data acquisition process and returns the procedure to the main process program.

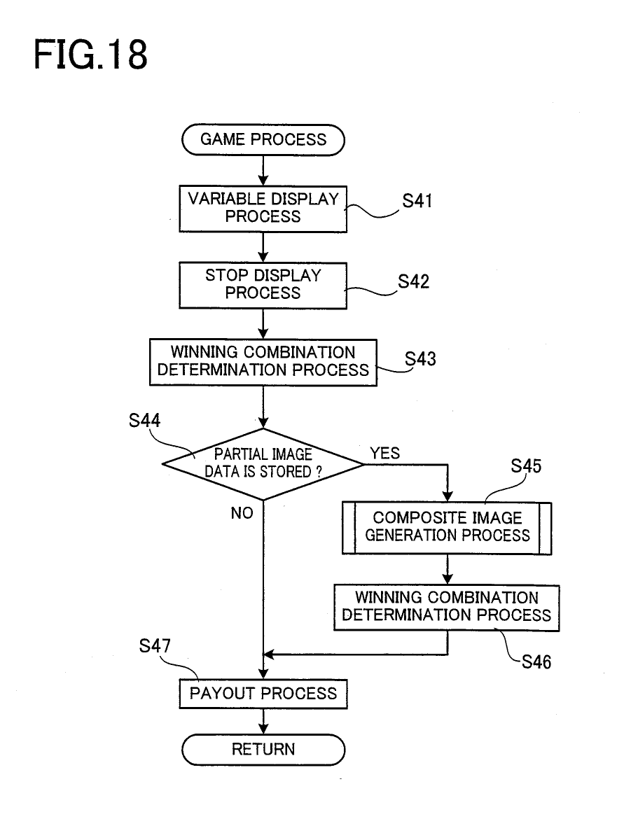

Next, the game process program executed in S7 of the main process program will be described with reference to FIG. 18. FIG. 18 is a flowchart of the game process program. In the main process program, the symbol lottery process (S5) and the partial image acquisition lottery process (S6) are executed, and the procedure is shifted to the game process (S7), the CPU 50 variable displays the video reel 100 in the variable display portions 22A to 22C, 23A to 23C, and 24A to 24C (S41) at first. By this means, in the variable display portions 22A, 22C, 23A to 23C, and 24A to 24C, each of the video reels 100 is variable displayed while being scrolled from the top to the bottom. If the predetermined time elapsed since variable display starts, the CPU 50 will stop and display each of the symbol in the variable display respectively (S42). After the stop and display process (S42) is executed, the CPU 50 will shift the procedure to S43.

In S43, the CPU 50 executes the winning combination determination process, which the winning combination and award contents corresponding thereof are determined based on the stopped and displayed symbols in the variable display portions 22A to 22C, 23A to 23C, and 24A to 24C in the symbol lottery process (S5). Concretely, the CPU 50 determines the winning combination (including the any odds winning combination and the line odds winning combination) and the payout based on the stopped and displayed symbols in each of the variable display portions and the payout table (see FIGS. 9 and 10). After the payout is stored in the RAM so as to be provided as the award, the CPU 50 shifts the procedure to S44.

When the procedure is shifted to S44, the CPU 50 determines whether the partial image data is stored in the image data storage area 52A. As mentioned above, as the value of the image acquisition counter 52B corresponds to the amount of the partial image data stored in the image data storage area 52A, the CPU 50 determines the condition of S44 by referring to the value of the image acquisition counter 52B. If the value of the image acquisition counter 52 is any of “1” to “3”, namely the partial image data is stored in the image data storage area 52A (S44:YES), the CPU 50 will shift the procedure to the composite image generation process (S45). On the other hand, if the image acquisition counter 52B is “0”, namely none of the partial image data is stored in the image data storage area 52A (S44:NO), the CPU 50 will shift the procedure to the payout process (S47) directly.

In the composite image generation process (S45), the composite image data is generated using the partial image data stored in the image data storage area 52A. Here, in the composite image generation process (S45) according to one or more illustrative embodiments, the pattern of the generated composite image data varies according to the amount of partial image data stored in the image data storage area 52A. Concretely, if three partial image data corresponding to the split pattern data is stored, the whole composite image data is generated using the three partial image data. On the other hand, if one or two partial image data is stored, the partial composite image data is generated by combining the partial image data stored and the display pattern displayed in the stop and display process (S42). After the partial composite image data or the whole composite image data is generated based on the amount of partial image data, the CPU 50 shifts the procedure to S46.

When the procedure is shifted to S46, the CPU 50 executes the composite winning combination determination process, which the winning combination and the payout are determined based on the combination of the symbols corresponding to the composite image data generated in the composite image generation process (S45). Here, either the partial composite image data or the whole composite image data includes the symbols displayed in nine variable display portions, so in the composite winning combination determination process, similarly to winning combination determination process (S25, S43) as mentioned above, it can be determined whether the line odds winning combination and the any odds winning combination (see FIGS. 9 and 10) are realized based on the symbol pattern in nine variable display portions. After the winning combination and the payout corresponding to the composite image data are determined based on the symbol pattern corresponding to the composite image data (the partial composite image data or the whole composite image data) and the payout tables (see FIGS. 9 and 10), the CPU 50 stores the determined payout in the RAM so that the payout is acquired as the special award. After that, the CPU 50 shifts the procedure to S47. Here, in this time, the composite image data (the partial composite image data or the whole composite image data) generated in the composite image generation process (S45) is displayed on the lower display 4.

When the procedure is shifted to S47, the CPU 50 executes the payout process, in which the award determined in the winning combination determination process (S43) and the special award determined in the composite winning combination determination process (S46) may be paid. Here, if none of the partial image data is stored in the image data storage area 52A (S44:NO), only the award corresponding to the winning combination determination process (S43) may be provided to the player. After the award and the special award are provided, the CPU 50 finishes the game process (S7), and returns the procedure to the main process program.

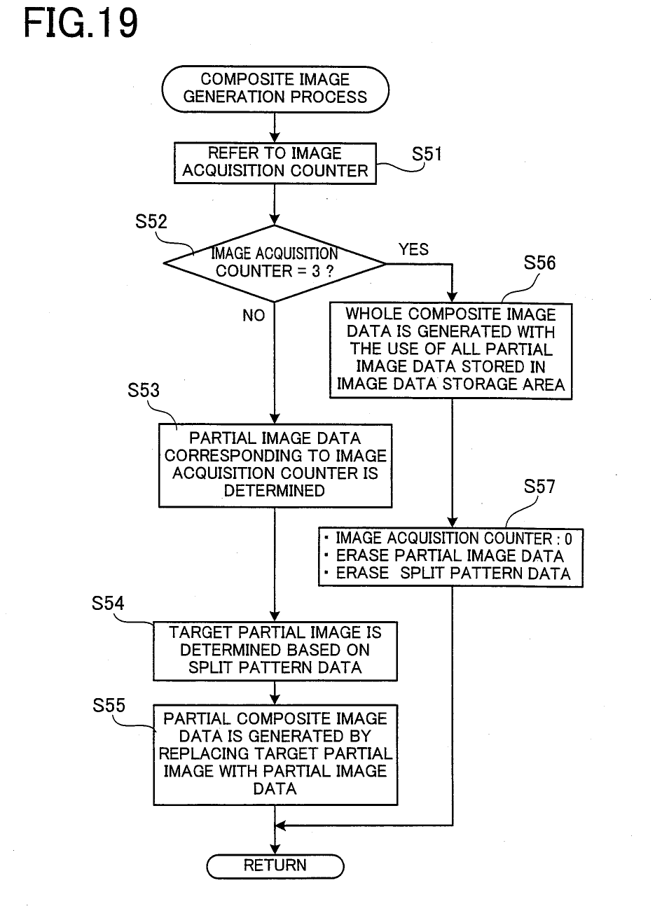

Next, the composite image generation process executed in S45 of the game process program will be described in detail with reference to the drawings. FIG. 19 is a flowchart of the composite image generation program. When the procedure is shifted to the composite image generation process (S45), the CPU 50 refers to the value of the image acquisition counter 52B (S51) at first. The CPU 50 determines whether the value of the image acquisition counter 52B is “3” (S52). If the value of the image acquisition counter 52B is “3” (S52:YES), the CPU 50 will shift the procedure to S56. In this case, three partial image data corresponding to the split pattern data is stored in the image data storage area 52A, so the CPU 50 generates the whole composite image data after the procedure at S56. On the other hand, if the value of the image acquisition counter 52B is not “3” (S52:NO), the CPU will shift to S53. In this case, the CPU 50 generates the partial composite image data after the procedure at S53.

If the procedure is shifted to S53, the CPU 50 determines the partial image data to be used the generation of the partial composite image data with reference to the value of the image acquisition counter 52B. In one and more embodiments, the partial image data used for the generation of the partial composite image data is the partial image data acquired in last partial image data acquisition process (S9). Thereby, if the value of the image acquisition counter 52B is “1”, the partial image data stored in the first storage area of the image data storage area 52A is used for the generation of the partial composite image data. If the value of the image acquisition counter 52B is “2”, the partial image data stored in the second storage area of the image data storage area 52A is used for the generation of the partial composite image data. After the partial image data to be used for the generation of the partial composite image data is determined based on the image acquisition counter 52, the CPU 50 shifts the procedure to S54.

In S54, the CPU 50 determines the displayed symbols (hereinafter “the target partial image”) which will be replaced. Namely, the partial image data determined in S53, which represents the target partial image, is generated from the display pattern displayed on the lower display 4), based on the split pattern data currently set and the value of the image acquisition counter 52B. For example, if the “split pattern (2)” as shown in FIG. 12 is set and the value of the image acquisition counter 52B is “2”, the partial images displayed in the variable display portions 22B, 23B, and 24B from the display pattern displayed on the lower display 4 are determined as the target partial images. Here, the target partial images may be a set or portion of symbols including one or more of the displayed symbols. After the target partial images are determined, the CPU 50 shifts the procedure to S55.

In S55, the CPU 50 generates the partial composite image by replacing the target partial images determined in S54 with the partial images determined in S53. Here, generated partial composite image is generated based on the images currently displayed on the low display 4, and the target partial images is replaced by the partial images determined in S53. For example, in above case, the partial composite image, in which the images corresponding variable display portions 22B, 23B, and 24B (the target partial images) are replaced by the partial images, is generated. After generated partial composite image data is stored in the RAM 52, the CPU 50 finishes the composite image generation process (S45), and shifts the procedure to the composite winning combination determination process (S46).

On the other hand, in S56 in which the procedure is shifted if the value of the image acquisition counter 52B is “3” (S52:YES), the CPU 50 generates the whole composite image data based on three partial image data stored in the first storage area to the third storage area of the image data storage area 52A. The partial image data currently stored in the image data storage area 52A was acquired based on the split pattern set in the split pattern determination process (S3) as mentioned above, so the whole composite image data corresponding to display portions displayed on the lower display 4 is generated by only combining the partial image data. For example, the “split pattern (2)” is set as shown in FIG. 12 and the value of the image acquisition counter 52B is “3”, three partial image data is stored in the image data storage area 52A. The partial image data corresponding to variable display portions 22A, 23A, and 24A is stored in the first storage area of the image data storage area 52A. In this time, the partial image data corresponding to variable display portions 22B, 23B, and 24B is stored in the second storage area. The partial image data corresponding to variable display portions 22C, 23C, and 24C is stored in the third storage area. Thereby, the whole composite image data corresponding to nine variable display portions 22A to 22C, 23A to 23C, and 23A to 24C is generated by combining three partial image data stored in the image data storage area 52A based on the split pattern data which is set. Thereby, one winning combination of the symbols (the whole composite image data) is generated based on difference three game results (the partial image data). After the whole composite image data is generated with the use of the three partial image data stored in the image data storage area 52A and the whole composite image data is stored in the RAM 52, the CPU 50 shifts the procedure to S57.

When the procedure is shifted to S57, the CPU 50 erases three partial image data stored in the image data storage area 52A if the whole composite image data is generated in S56. The CPU 50 set the value of the image acquisition counter 52B to “0” based on the erasure of the partial image data. In this time, the CPU 50 erases the split pattern which is currently set. By this means, in the slot machine 1, in the next game, the partial image data can be acquired based on different split pattern. After the partial image data is erased, the CPU 50 finishes the composite image generation process (S45), and shifts the procedure to the composite winning combination determination process (S46).

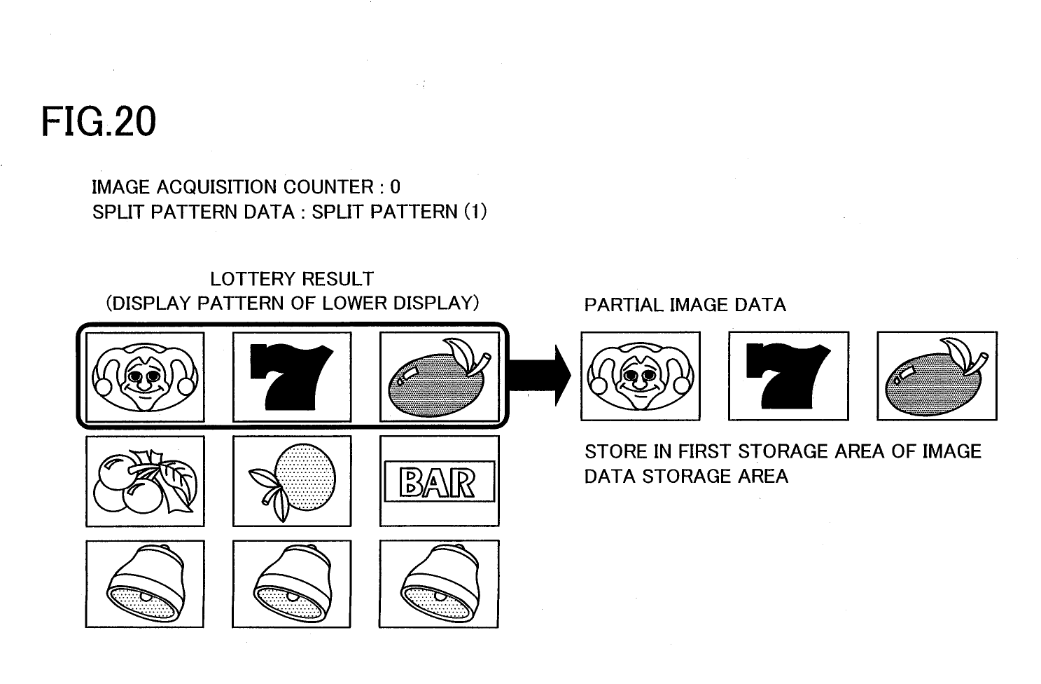

Here, the game in the slot machine of one or more embodiments will be described in detail with reference to drawings. For example, the case, where the value of the image acquisition counter 52B is “0” and the “split pattern (1)” is determined in the split pattern determination process (S3), will be described with reference to FIG. 20. In the symbol lottery process (S5), if the partial image acquisition lottery process (S6) is won based on the random result, which “CHERRY” 110, “ORANGE” 109, and “BAR” 104 are displayed in variable display portions 22A to 22C, “WILD” 101, “BLUE7” 102, and “PLUM” 108 are displayed in to variable display portions 23A to 23C, and “BELL” 106, “BELL” 106, and “BELL” 106 are displayed in to variable display portions 22A to 22C, the CPU 50 displays the random result of the symbol lottery process (S5) (see FIG. 20) on the lower display 4 (S41, S42) in the game process (S7). Here, in the random result, the winning combination “BELL” 106 corresponding to the line odds winning combination “ANY-4 of BELL” corresponding to the any odds combination are won, so the payout “5” corresponding to above random result is determined as the award (S43). In this time, the partial image data is not stored in the image data storage area 52A (S44:NO), so the payout “5” determined in the winning combination determination process (S43) is directly provided as the award (S43).

After the game process is executed (S7), the partial image data is acquired (S9) from the display pattern of the lower display 4 based on the winning in the partial image acquisition lottery process (S6). In this case, the partial images displayed in the variable display portions 23A to 23C is acquired based on the “split pattern (1)” and “the image acquisition counter 52B=0”. That is, the partial image including “WILD” 101, “BLUE7” 102, and “PLUM” 108 displayed in the variable display portions 23A to 23C is stored in the first storage area of the image data storage area 52A (see FIG. 20). Here, the image acquisition counter 52B is added to “1”, so the value of the image acquisition counter 52B is “1” (S34). Here, in the random result, “WILD” symbol 102 is not stopped and displayed in the variable display portion 22B (S10:NO), so the CPU 50 shifts the procedure to S2 directly.

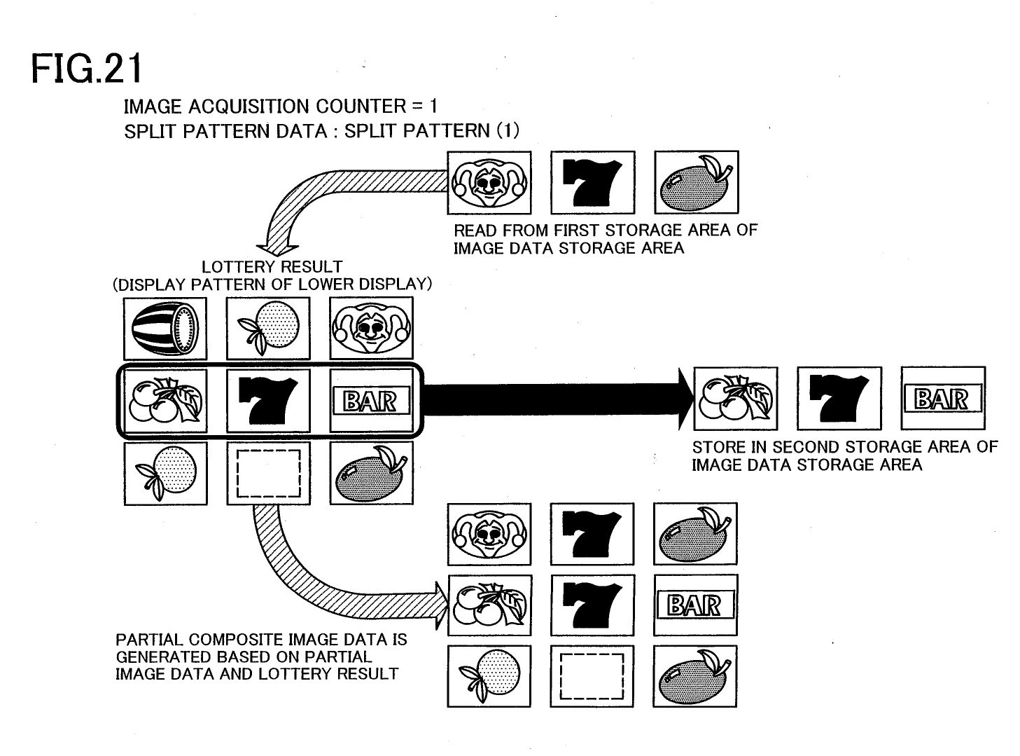

And, when the game is continued, the partial image data is already stored in the first storage area, so next game can be conducted without determining the split data. The case where the partial image acquisition lottery process (S6) is won, will be described with reference to FIG. 21. For example, as shown in FIG. 21, in the symbol lottery process (S5), if the random result, which “CHERRY” 110, “BLUE7” 102, and “BAR” 104 correspond to variable display portions 22A to 22C, “WATER MELLON” 107, “ORANGE” 109, and “WILD” 104 correspond to variable display portions 23A to 23C, and “WATER MELLON” 107, “BLANK” 111, and “PLUM” 108 correspond to variable display portions 22A to 22C, is acquired, the random result as shown in FIG. 21 will be displayed on the lower display 4 in the game process (S7). In this case, in the winning determination process (S43), any winning combination is not realized in the random result, so the payout “0” is determined. And, as mentioned above, the partial image data is stored in the first image storage of the image data storage area 52A, so the CPU 50 generates the partial composite image data in the composite image generation process (S45).

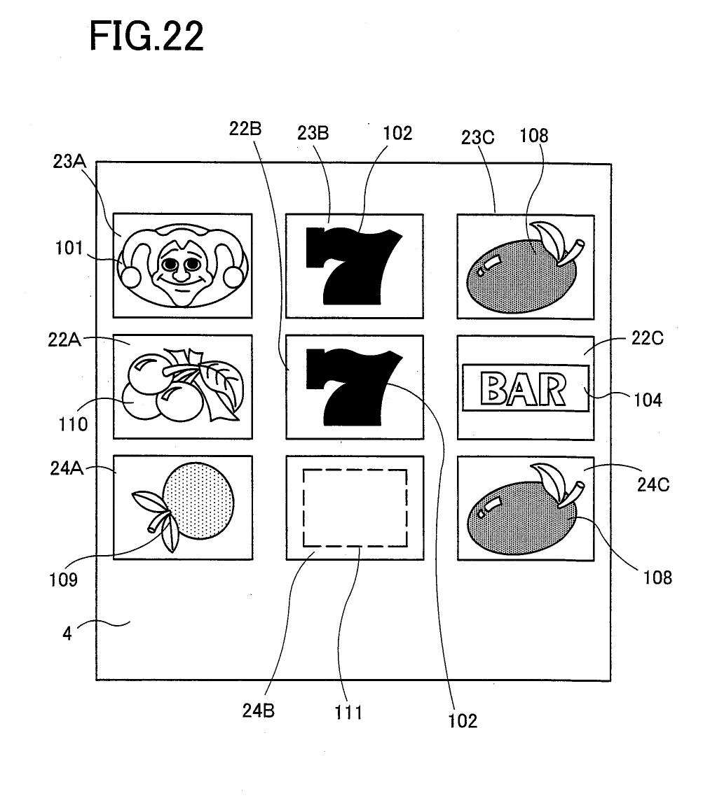

In the composite image generation process (S45), the partial composite image data is generated with the use of the image corresponding to above random result and the partial image data identified that the image acquisition counter 52B is “1” (namely, the partial image data stored in the first storage area). As mentioned above, the partial image data including “WILD” 101, “BLUE7” 102, and “PLUM” 108 corresponding to the variable display portions 23A to 23C is stored in the first storage area of the image data storage area 52A, so the partial composite image data, in which “WATER MELLON” 107, “ORANGE” 109, and “WILD” 101 corresponding to the variable display portions 23A to 23C (random result) are replace by “WILD” 101, “BLUE7” 102, and “PLUM” 108 corresponding to above partial image data, is generated (see FIG. 21). In the composite winning combination lottery process (S46), the CPU 50 displays the partial composite image data generated in the composite image generation process (S45) on the lower display 4 (see FIG. 22), and determines the special award contents based on the display contents of the symbols corresponding to the partial composite image data. Here, in this case, the winning combination “ANY-3 of ANY7” is won as the winning combination corresponding to the partial composite image data, so the payout “1” is acquired as the special award (S47). That is, the payout based on the random result of the symbol lottery process (S5) is “0”, however, the special award is acquired, so the player can feel the interest such as “surprise” for the acquisition of the special award. The game process (S7) is finished. After that, as the partial image acquisition lottery process (S6) is won, the CPU 50 executes the partial image data acquisition process (S9).

In this case, the CPU 50 acquires the partial image data corresponding to the variable display portions 22A to 22C among the display pattern currently displayed on the lower display 4 based on the “split pattern (1)” and “the image acquisition counter 52B=1”. That is, the partial image data including “CHERRY” 110, “BLUE7” 102, and “BAR” 104 displayed in the variable display portions 22A to 22C is stored in the second storage area of the image data storage area 52A (see FIG. 21). Here, in this case, the value of the image acquisition counter 52B is added to “1”, so the value of the image acquisition counter 52B will be “2” (S34). Here, in this case, as “WILD” 101 is not also stopped and displayed in the variable display portion 22B based on the random result, the CPU 50 shifts the procedure to S2 directly.

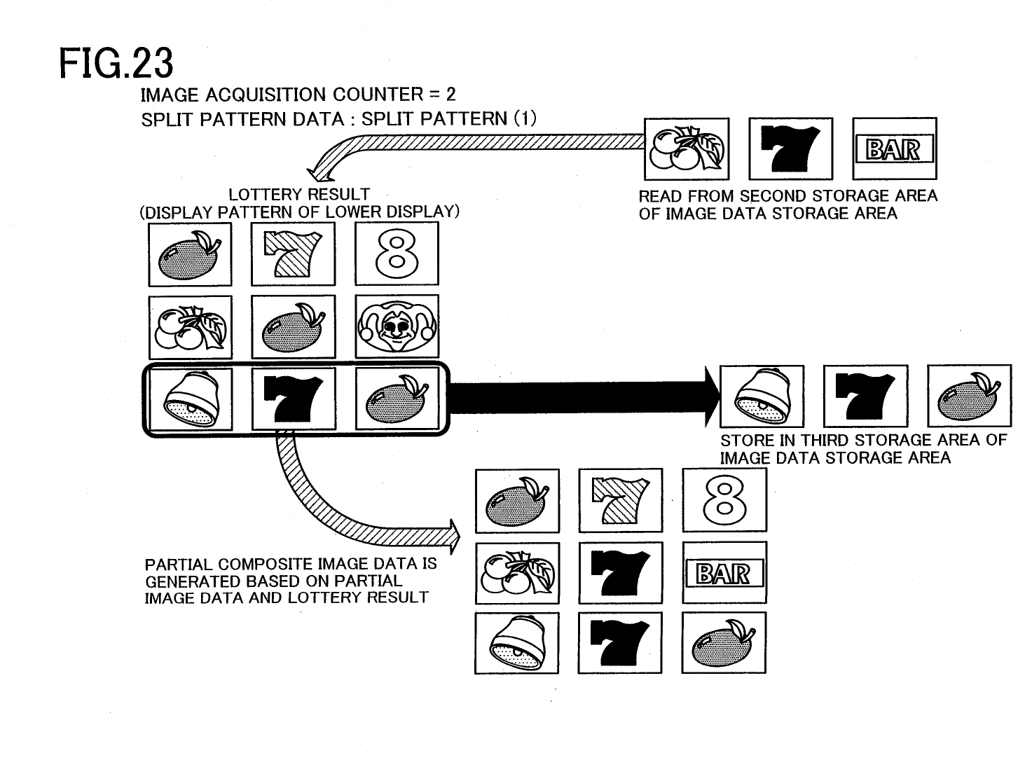

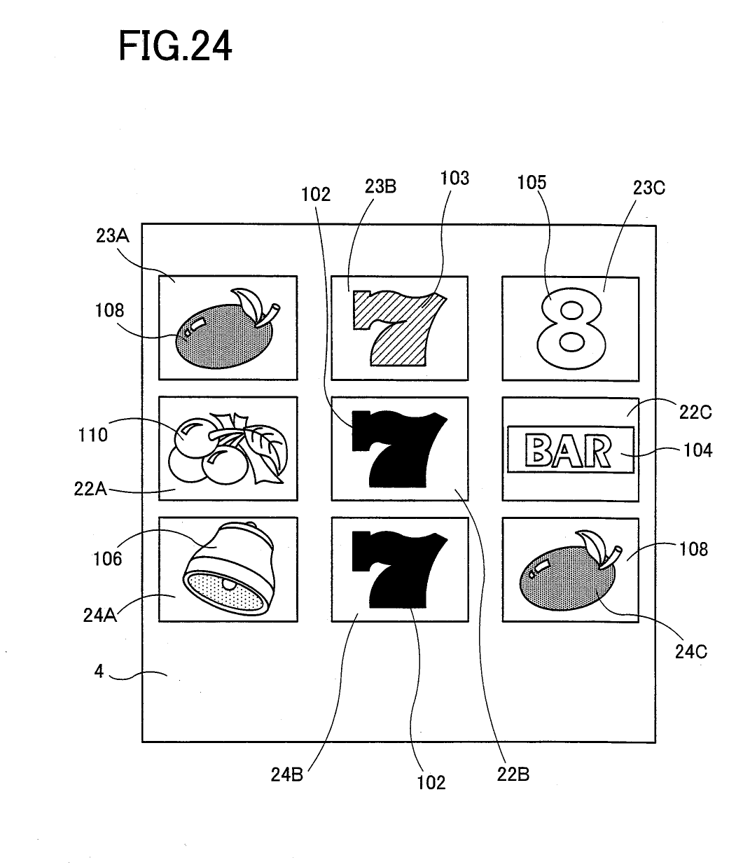

When the game is continued, as the partial image data is also stored in the first storage area and the second storage area, next game can be conducted without determining the split data. The case, which the partial image acquisition lottery process (S6) is won, will be described with reference to FIG. 23. For example, as shown in FIG. 23, if the random result, in which “CHERRY” 110, “PLUM” 108, and “WILD” 101 correspond to variable display portions 22A to 22C, “PLUM” 108, “RED7” 103, and “EIGHT” 105 correspond to variable display portions 23A to 23C, and “BELL” 106, “BLUE7” 102, and “PLUM” 108 correspond to variable display portions 22A to 22C, is acquired in the symbol lottery process (S5), the random result as shown in FIG. 23 will be displayed on the lower display 4 in the game process (S7). In this case, in the winning combination determination process (S43), the winning combination “BLUE7-RED7-ANY”, the any odds winning combination “ANY-4 of PLUM”, and “ANY-3 of ANY7” are won, so the payout “13” is determined as the award. As mentioned above, as the partial image data is stored in the first storage area and the second storage area, the CPU 50 generates the partial composite image data in the composite image generation process (S45).

In the composite image generation process (S45), the partial composite image data is generated with the use of the image corresponding to above random result and the partial image data identified that the image acquisition counter 52B is “2” (namely, the partial image data stored in the second storage area). As mentioned above, in the second area of the image data storage area 52A, the partial image data including “CHERRY” 110, “BLUE7” 102, and “BAR” 104 corresponding to the variable display portions 22A to 22C are stored, so the partial composite image data constructed from “CHERRY” 110, “BLUE7” 102, and “BAR” 104 corresponding to above partial image data is generated (see FIG. 23). In the composite winning combination lottery process (S46), the CPU 50 displays the partial composite image data generated in the composite image generation process (S45), and determines the special award based on the display pattern of the symbols corresponding to above partial image composite data. Here, in this case, the line odds winning combination “BLUE7-RED7-ANY” and the any odds winning combination “ANY3 of ANY7” are realized as the winning combination corresponding to above partial composite image data, so the payout number “11” are awarded as the special award (S47). After the game process (S7) is finished, as mentioned above, as the partial image acquisition lottery process (S6) is won, the CPU executes the partial image data acquisition process (S9)

In this case, the CPU 50 acquires the partial image data corresponding to the variable display portions 24A to 24C out of the display content currently displayed on the lower display. That is, the partial image data including “BELL” 106, “BLUE7” 102, and “PLAM” 108 displayed on the variable display portions 24A to 24C are stored in the third storage area of the image data storage area 52A (see FIG. 23). Here, in this time, “1” is added to the image acquisition counter 52B, in this result, it becomes “the image acquisition counter 52B=3” (S34). In this case, as “WILD” 101 is not stopped and displayed based on above random result (S10:NO), the CPU 50 shifts the procedure to S2 directly.

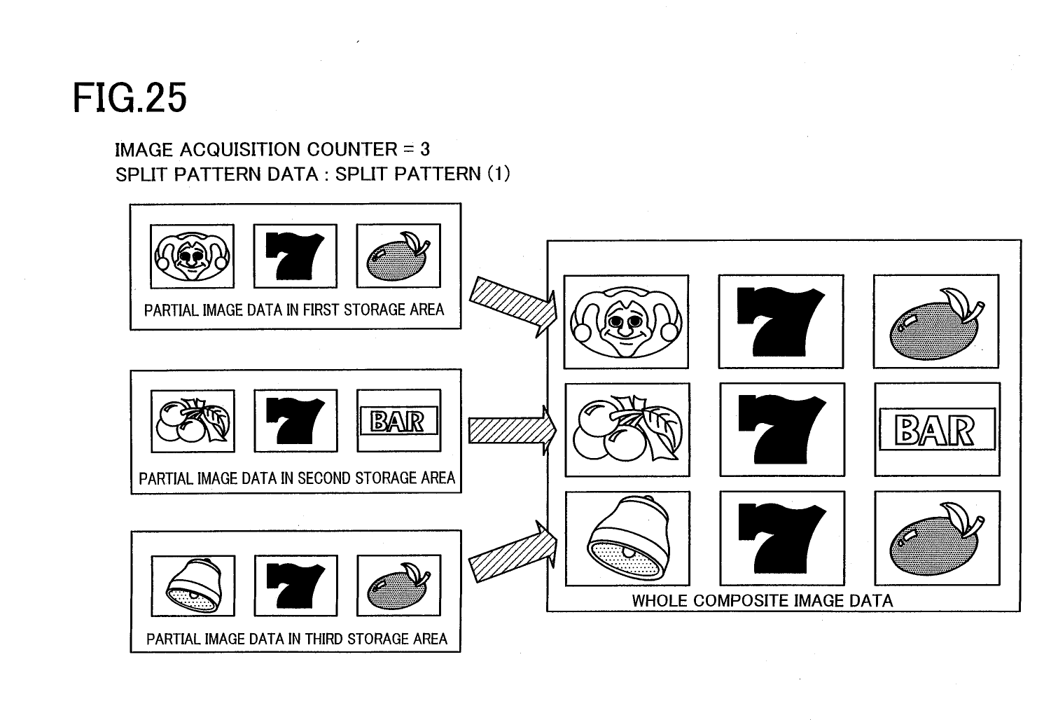

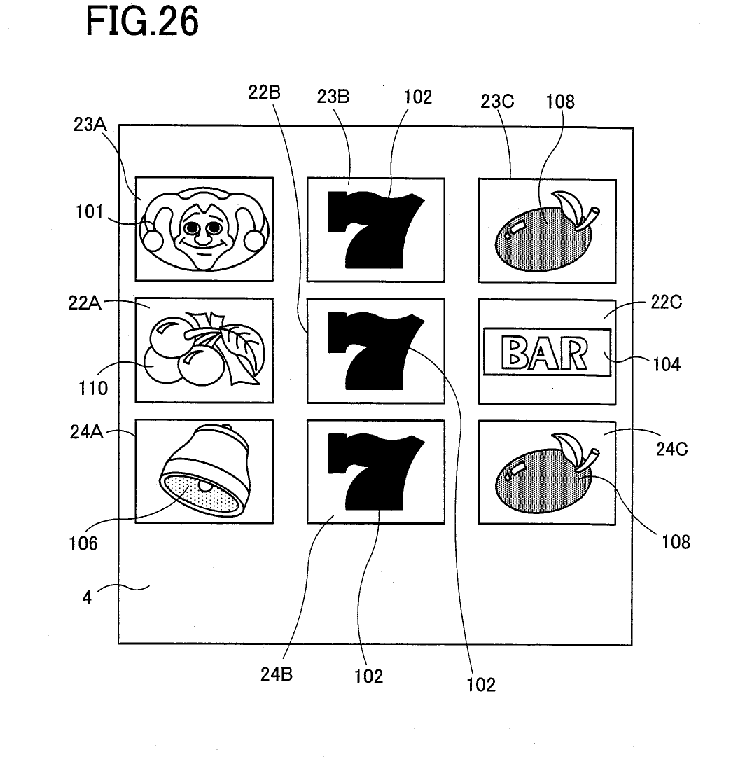

In this way, if the partial image data are stored in the first storage area to the third storage area of the image data storage area 52A respectively, the whole composite image data will be generated with the use of above three partial image data in the game process (S7) in the next game. In this concrete example, the partial image data including “WILD” 101, “BLUE7” 102, and “PLUM” 108 corresponding to the variable display portions 23A to 23C are stored in the first storage area of the image data storage area 52A. The partial image data including “CHERRY” 110, “BLUE7” 102, and “BAR” 104 corresponding to the variable display portions 22A to 22C are stored in the second stage area, and the partial image data including “BELL” 106, “BLUE7” 102, and “PLUM” 108 corresponding to the variable display portions 24A to 224 are stored in the third storage area. Thereby, in the composite image generation process (S45), as shown FIG. 25, the whole composite image data is generated with the use of partial image data stored in the first storage area to the third storage area of the image data storage area 52A. That is, the whole composite image data is the pattern data, which “CHERRY” 110, “BLUE7” 102, and “BAR” 104 are displayed in the variable display portions 22A to 22C, “WILD” 101, “BLUE7” 102, and “PLUM” 108 are displayed in the variable display portions 23A to 23C, and “BELL” 106, “BLUE7” 102, and “PLUM” 108 are displayed in the variable display portions 24A to 24C (see FIG. 25).

The whole composite image data generated by this means is displayed on the lower display 4 in the composite winning combination determination process (S46) (see FIG. 26). In above composite winning combination determination process (S46), it is determined whether the winning combination is realized based on the symbol combination corresponding to above whole composite image data. In this case, “BLUE7”s 102 are respectively displayed in the variable display portions 22B, 23B and 24B, so the line odds winning combination “BLUE7” 102 is realized. Thereby, it is determined that the special award corresponding to above whole composite image data is the payout number “30” based on the payout table corresponding to the line odds (see FIG. 9). The payout number “30” as the special award corresponding to the whole composite image data is awarded regardless of the random result of the symbol lottery process (S7), so the player can get the interest such as “surprise” based on the unexpected payout.

As mentioned above, in the slot machine 1 of one or more illustrative embodiments, the game, which it is determined whether the line odds winning combination and the any odds winning combination are won based on the combination of the symbols (“WILD” 101 to “BLANK” 111) stopped and displayed on the lower display 4 and the award (including the payout or the bonus game) is provided, is executed. Here, in the slot machine 1, if the partial image acquisition lottery process (S6) is won, the part of the display pattern currently displayed on the lower display 4 is stored in the image data storage area 52A as the partial image data based on the split pattern determined in the split pattern determination process (S3) in the partial image data acquisition process (S9). If the partial image data is stored in the image storage area 52A, the composite image data will be generated with the use of the partial image data stored in the image data storage area 52A in the game process (S7). The generated composite image data is used to determine the special award in the composite winning combination determination process (S46). As the special award is determined using the partial image data from a previous game, the player may not expect a special award, and upon receipt of such an award may experience further enjoyment of the game. That is, by using the partial image data acquired in the partial image data acquisition process (S9), player's interest in playing the slot machine 1 may increase.

In the slot machine 1, if three partial image data is stored in the image data storage, the whole composite image data is generated with the use of the partial image data as to construct the whole of the lower display 4 (S56). As the winning combination corresponding to the special award is determined based on the combination of the symbols constructed from three partial image data which is the part of the different game results, the player may not expect the special award, and upon receipt of such an award may experience further enjoyment of the game. That is, by using the partial image data acquired in the partial image data acquisition process (S9), player's interest in playing the slot machine 1 may increase.

If one or two partial image data is stored in the image data storage area 52A of the slot machine 1, the partial composite image data is generated using the partial image data acquired immediately preceding image data acquisition process (S9) and the display pattern currently displayed on the lower display 4. As the special award is determined based on the contents, which the part of the game result in the partial image data acquisition process (S9) and the current game result are combined, the player may not expect a special award, and upon receipt of such an award may experience further enjoyment of the game. That is, by using the partial image data acquired in the partial image data acquisition process (S9), player's interest in playing the slot machine 1 may increase.

Here, aspects of the present invention are not limited to the above embodiment and various changes and modification can be done within the scope of the present invention. For example, according to one or more illustrative embodiments, the split pattern data to determine the acquisition pattern of partial image data is set six patterns including “split pattern (1)” to “split pattern (6)”, however, one or more embodiments are not so limited. That is, more patterns or fewer patterns may be set. And more, according to one or more illustrative embodiments, the display contents of the lower display 4 is split so that the whole composite image data is generated from three variable display portions in three times, however, one or more embodiments are not so limited. For example, the unit of the variable display portion acquired every one partial image data acquisition process (S9) can be changed. And, the execution number of times of the partial image data acquisition process (S9), which the whole composite image data is constructed, can be changed. For example, the partial image data including four images corresponding to four variable display portions can be acquired in the first partial image data acquisition process, the partial image data including two images corresponding to two variable display portions can be acquired in the second partial image data acquisition process, the partial image data including two images corresponding to two variable display portions can be acquired in the third partial image data acquisition process, and the partial image data including one image corresponding to one variable display portions can be acquired in the fourth partial image data acquisition process.

And, one or more embodiments, the partial composite image data is generated with the only use of the partial image data acquired in current partial image data acquisition process (S9) (namely, the partial image data stored in the second storage area) if two partial image data is stored in the image data storage area 52A, however, the partial composite image data can be generated with the all use of the partial image data is already stored (namely, the partial image data stored in the first storage area and the second storage area). And more, if three partial image data is stored in the image data storage area 52A, the whole composite image data is generated with the use of three partial image data stored in the first storage area to the third storage area and the special award is awarded based on the whole composite image data, however, the partial composite image data can be constructed based on the partial image stored in the third storage area and the current game result in addition to the generation of the whole composite image data. Thereby, if three partial image data is stored in the image data storage area 52A, as the special award based on the partial composite image data is provided to the player in addition to the award based on the current game result and the special award based on the whole composite image data, player's interest in playing the slot machine 1 may increase.

And, according to one or more illustrative embodiments, in the bonus game process (S11), it is not constructed that the partial image data acquisition process is executed, however, it can be constructed that the partial image data acquisition process is executed in the bonus game process (S11). And, in the bonus game (S11), it can be constructed that the composite image data (the partial composite image data or the whole composite image data) is generated and the special award based on the composite image data is awarded.

And, according to one or more illustrative embodiments, while “WILD” 101 is fix-displayed in the variable display portion 22B, the free game in which the symbols are stopped and displayed in other eight variable display portions is conducted as the bonus game, however, one or more embodiments are not so limited. For example, so-called double up game can be used as the bonus game.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display configured to display symbols;
a memory configured to store the displayed symbols; and
a processor programmed to:
(a) replace a displayed symbol with a symbol stored in the memory if the stored symbol was displayed on the display and stored in a previous game, and
(b) provide an award based on a combination of symbols displayed on the display after the displayed symbol has been replaced with the stored symbol.

2. The gaming machine according to claim 1, wherein the processor is programmed to cause a portion of the displayed symbols to be stored in the memory.

3. The gaming machine according to claim 2, wherein the processor is programmed to determine which one of a plurality of portions of the displayed symbols is to be stored in the memory based on a predetermined split pattern.

4. The gaming machine according to the claim 1, wherein the processor is programmed to cause the memory to store the displayed symbols when a condition is satisfied.

5. The gaming machine according to claim 1, wherein the processor is programmed to replace a portion of the displayed symbols.

6. The gaming machine according to claim 5, wherein the processor is programmed to determine which one of a plurality of portions of the displayed symbols is to be replaced based on a predetermined split pattern.

7. A method comprising:
storing a first set of symbols during a first game;
displaying a second set of symbols during a second game;
replacing the second set of displayed symbols during the second game session with the first set of stored symbols, wherein the first game is prior to the second game; and
providing an award based on a combination of symbols displayed after the second set of symbols has been replaced with the first set of stored symbols.

8. The method according to claim 7, further comprising:
displaying a third set of symbols concurrently with the displaying of the second set of symbols during the second game.

9. The method according to claim 8, further comprising:
storing a fourth set of symbols during the second game, the fourth set of symbols including symbols from at least one of the displayed second and third sets of symbols.

10. The method according to claim 8, wherein the combination of the symbols includes the third set of symbols.

11. The method according to claim 8, further comprising:
determining that the second set of symbols is to be replaced from among the second and third sets of symbols displayed during the second game based on a predetermined split pattern.

12. The method according to claim 7, wherein the first set of symbols is displayed during the first game prior to being stored.

13. The method according to claim 12, further comprising:
displaying a third set of symbols concurrently with the displaying of the first set of symbols during the first game; and
determining that the first set of symbols is to be stored from among the first and third set of symbols displayed during the first game based on a predetermined split pattern.

14. A tangible computer readable medium having computer-executable instructions stored thereon that, when executed by a processor, perform a method comprising the steps of:
storing a first set of symbols during a first game;
displaying a second set of symbols during a second game;
replacing the second set of displayed symbols during the second game session with the first set of stored symbols, wherein the first game is prior to the second game; and
providing an award based on a combination of symbols displayed after the second set of symbols has been replaced with the first set of stored symbols.

15. The tangible computer readable medium according to claim 14, further comprising:
displaying a third set of symbols concurrently with the displaying of the second set of symbols during the second game.

16. The tangible computer readable medium according to claim 15, further comprising:
storing a fourth set of symbols during the second game, the fourth set of symbols including symbols from at least one of the displayed second and third sets of symbols.

17. The tangible computer readable medium according to claim 15, wherein the combination of the symbols includes the third set of symbols.

18. The tangible computer readable medium according to claim 15, further comprising:
determining that the second set of symbols is to be replaced from among the second and third sets of symbols displayed during the second game based on a predetermined split pattern.

19. The tangible computer readable medium according to claim 14, wherein the first set of symbols is displayed during the first game prior to being stored.

20. The tangible computer readable medium according to claim 19, further comprising:
displaying a third set of symbols concurrently with the displaying of the first set of symbols during the first game; and
determining that the first set of symbols is to be stored from among the first and third set of symbols displayed during the first game based on a predetermined split pattern.
